(19) United States
(12) Patent Application Publication
(10) Pub. No.: US 2003/0157367 A1
(43) Pub. Date: Aug. 21, 2003

(54) Blue light-emitting polymer containing 9, 10-diphenylanthracene moiety and electroluminescent device using the same

(75) Inventors: Hong You, Yusung-gu (KR); Dong-Jin Joo, Yusung-gu (KR); Gil-Su Kwak, Yusung-gu (KR); Jong-Wook Kim, Yusung-gu (KR); Soon-Ki Kwon, Gazwa-dong (KR); Yun-Hi Kim, Gazwa-dong (KR); Dong-Cheol Shin, Gazwa-dong (KR); Hyung-Sun Kim, Gazwa-dong (KR); Hyun-Cheol Jeong, Gazwa-dong (KR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SK CORPORATION

(21) Appl. No.: 10/290,808

(22) Filed: Nov. 8, 2002

(30) Foreign Application Priority Data
Nov. 9, 2001 (KR) 2001-69770
Jan. 4, 2002 (KR) 2002-00508

(51) Int. Cl. H05B 33/14; C09K 11/06; C08G 61/02

(52) U.S. Cl. 428/690; 428/917; 252/301.16; 252/301.35; 313/504; 313/506; 257/40; 528/394; 528/397; 526/280

(57) ABSTRACT

There are provided novel blue light-emitting organic electroluminescent polymers having a main chain consisting of 9,10-diphenylanthracene and vinylene, and electroluminescent devices using the same. With the introduction of substituents which are of high thermal stability and are capable of steric hindrance at the alpha position of the vinyl group, the electroluminescent polymers make it easy to conduct inter- and intra-molecular energy transfer, and the injection and transportation of holes or electrons, as well as restraining π-stacking between polymer chains. Also, the prevention of intermolecular two- and three-dimensional interference by the introduced bulky substituents leads to reduced extinction of excitons, whereby the organic electroluminescent device can emit blue light at high luminous efficiency.

### BACKGROUND OF THE INVENTION

1. Field of the Invention

The present invention relates to a blue light-emitting polymer containing a 9,10-diphenylanthracene moiety and an electroluminescent device (hereinafter referred to as “EL device”) device using the same. More particularly, the present invention relates to a blue light-emitting polymer having a main chain consisting of 9,10-diphenylanthracene and vinylene of high thermal resistance, into which bulky and functional substituents are introduced to exclude intermolecular interference as much as possible, make intra- and inter-molecular energy transfer possible, and facilitate the injection and transportation of holes or electrons, thereby emitting blue light at high luminous efficiency.

2. Description of the Prior Art

With the recent great advance in the optical communication and multi-media fields, the progress toward highly information-intensive societies has been accelerated. Among the electronic devices invented thus far, an optoelectronic device which takes advantage of the conversion of photons to electrons or vice versa is appearing as the device-of-the-modern information/electronic industry. Largely, optoelectronic devices are classified into EL devices, photodiodes, and combinations thereof. Optoelectronic displays in current use are, for the most part, of photodiode types. However, electroluminescent displays have attracted intensive attention as next-generation displays because of their various advantages, including rapid response speed, requirement of no backlight owing to self-luminosity, excellent brightness, etc.

Depending on their materials building up electroluminescent layers, EL devices are classified into organic and inorganic devices. Based on p-n junctions of inorganic semiconductors such as GaN, ZnS and SiC, inorganic EL devices enjoy the advantage of high efficiency, small size, long lifetime, and low powder consumption, finding numerous applications in various fields including small-size displays, light emitting diode (LED) lamps, semiconductor lasers, etc. However, inorganic EL devices require turn-on voltages of AC 200 V or higher and are difficult to apply to large-size screens because they are fabricated by vacuum deposition, in addition to having difficulty in obtaining blue light therefrom efficiently.

In order to overcome these drawbacks of inorganic EL devices, organic electroluminescence was applied to EL devices as reported in Appl. Phys. Letter, 51, p 913(1987); Nature 347, p 539(1990). Generally speaking, organic electroluminescence is the emission of light, resulting from the successive processes in which, upon application of an electric field to an organic material, electrons and holes are injected from a cathode and an anode, respectively, transported to the organic material, and recombined in the organic material, giving fluorescence. The electroluminescence of organic materials was first reported by Pope et al., 1963 and developed into a multi-layer structured EL device which is based on the π-conjugated structure of alumina-quinone and shows a quantum efficiency of about 1% and a luminance of about 1000 cd/m² at 10 V or lower, by Tang et al., Eastman Kodak, 1987. Since then, extensive research into organic EL devices has been conducted worldwide. The π-conjugated structure of alumina-quinone can be easily applied for the synthesis of various materials owing to its simple synthesis pathway, and has the advantage of being color-tunable. However, alumina-quinone is poor in processability and heat stability. In addition, when applying an electric field across alumina-quinone, joule heat may be generated in the luminescent layer to cause the rearrangement of molecules to destroy the device. To solve the problems thus caused in luminescent efficiency and device lifetime, novel acting polymeric structures capable of light emission in the presence of an electric field are being developed actively.

In order to better understand the background of the invention, a typical organic EL device is described in conjunction with FIG. 25. As shown in the schematic cross-sectional view of FIG. 25, an organic EL device typically has a structure of substrate 11/anode 12/hole transport layer 13/luminescent layer 14/electron transport layer 15/cathode 16, which are formed, in order, from bottom to top. The hole transport layer 13, the luminescent layer 14 and the electron transport layer 15 are in the form of thin film made of organic compounds.

As a rule, an organic electroluminescent device with the structure of FIG. 25 converts electrical energy into light through the production and extinction of exitons. In detail, when an electric potential is applied between the anode 12 and the cathode 16, holes are injected from the anode 12 and then transported through the hole transport layer 13 to the luminescent layer 14. While, electrons are injected through the electron transport layer 15 into the luminescent layer 14 from the cathode 16. In the luminescent layer 14, the charge carriers are recombined to produce excitons which are then migrated from an exited state to a ground state, during which the fluorescent molecules of the luminescent layer emit light, giving an image.

Organic materials used for the formation of organic films of EL devices may be of low molecular weights or high molecular weights. Where low-molecular weight organic materials are applied, they can be easily purified to an impurity-free state, and thus is excellent in terms of luminescence properties. However, low-molecular weight materials do not allow spin coating, and are of poor heat resistance such that they are deteriorated or re-crystallized by the heat generated during the operation of the device. On the other hand, in the case of a polymer, an energy level is divided into a conduction band and a valance band, as wave functions of π-electrons present in its backbone overlap with each other. The band gap between the conduction band and the valence band defines the semiconductor properties of the polymer and thus, control of the band gap may allow the visualization of full colors. Such a polymer is called a π-conjugated polymer. The first development of an EL device based on the conjugated polymer poly(p-phenylenevinylene) (hereinafter referred to as “PPV”) by a research team led by Professor R. H. Friend, Cambridge University, England, 1990 has stimulated extensive active research into organic polymers of semiconductor properties. In addition to being superior to low-molecular weight materials in heat resistance, polymeric materials can be applied to large-surface displays by virtue of their ability to be spin coated. PPV and polythiopene (Pth) derivatives in which various functional moieties are introduced are reported to be improved in processability and exhibit various colors. However, such PPV and Pth derivatives, although applicable for emission of red and green light at high efficiency, have difficulty in emitting blue light at high efficiency. Polyphenylene derivatives and polyfluorene derivatives are reported as blue light-emitting materials. Polyphenylene is of high stability against oxidation and heat, but of poor luminescence efficiency and solubility. Despite being the focus of extensive research, polyfluorene derivatives are still required to exclude the inference of excitons of a molecule with those of neighboring another molecule as much as possible.

### SUMMARY OF THE INVENTION

Leading to the present invention, the intensive and thorough research into blue light-emitting organic electroluminescent polymers, conducted by the present inventors in an aim to solve the above problems encountered in prior arts, resulted in the finding that the introduction of bulky substituents into an electroluminescent polymer has the effect of restraining π-stacking between polymer chains, increasing band gaps, and preventing intermolecular interference, thereby allowing emission of blue light of high color purity at high luminous efficiency.

Therefore, it is an object of the present invention to provide a blue light-emitting organic electroluminescent polymer, which is highly stable to heat and oxidation and shows minimal intermolecular interference, in addition to being excellent in terms of energy transfer.

It is another object of the present invention to provide an electroluminescent device adopting the organic electroluminescent polymer as a material for a luminescent layer or hole transport layer.

Based on the present invention, the above objects could be accomplished by a provision of an organic electroluminescent polymer, having a main chain consisting of 9,10-diphenylanthracene and vinylene, represented by the following chemical formula 1:

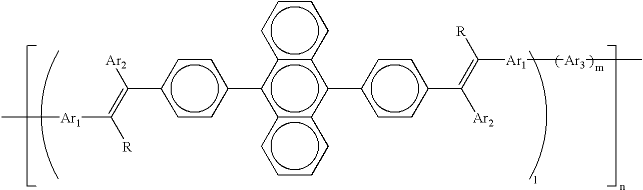

wherein,

Ar₁ and Ar₃ are identical or different, and are selected from the group consisting of:

a non-substituted, C1-C25 alkyl-substituted, or C1-C25 alkoxy-substituted arylene group of 6 to 30 carbon atoms; an arylene group of 10 to 24 atoms having fused aromatic ring such as naphtylene and anthrylene; an arylene group of 6 to 30 carbon atoms, substituted with an alkyl amino group of 1 to 25 carbon atoms or with an aryl amino group of 6 to 30 carbon atoms; a carbazole derivative having an alkyl group of 1 to 25 carbon atoms or an aryl group of 6 to 30 carbon atoms; a fluorenylene group having, at position 9, an alkyl group of 1 to 25 carbon atoms, a polyalkoxide group of 1 to 25 carbon atoms, or an aryl group substituted with an alkyl or alkoxy group of 1 to 25 carbon atoms; a silylene group substituted with an alkyl group of 1 to 25 carbon atoms, an alkoxy group of 1 to 25 carbon atoms, or aryl group of 6 to 30 carbon atoms; and an arylene group of 6 to 30 carbon atoms having a silyl group substituted with an alkyl group of 1 to 25 carbon atoms, an alkoxy group of 1 to 25 carbon atoms or an aryl group of 6 to 30 carbon atoms;

Ar₂ and R are identical or different, and are selected from the group consisting of:

a hydrogen atom; a non-substituted, C1-C25 alkyl-substituted, or C1-C25 alkoxy-substituted aryl group of 6 to 30 carbon atoms; an aryl group of 10 to 24 atoms having fused aromatic ring such as naphtyl and anthryl; an aryl group of 6 to 30 carbon atoms, substituted with an alkyl amino group of 1 to 25 carbon atoms or with an aryl amino group of 6 to 30 carbon atoms; a carbazole derivative having an alkyl group of 1 to 25 carbon atoms or an aryl group of 6 to 30 carbon atoms; a fluorenyl group having, at position 9, an alkyl group of 1 to 25 carbon atoms, a polyalkoxide group of 1 to 25 carbon atoms, or an aryl group substituted with an alkyl or alkoxy group of 1 to 25 carbon atoms; a silyl group substituted with an alkyl group of 1 to 25 carbon atoms, an alkoxy group of 1 to 25 carbon atoms, or aryl group of 6 to 30 carbon atoms; an aryl group of 6 to 30 carbon atoms having a silyl group substituted with an alkyl group of 1 to 25 carbon atoms, an alkoxy group of 1 to 25 carbon atoms or an aryl group of 6 to 30 carbon atoms; and a cyano or fluoro group;

l is an integer of 1 to 100,000 and m is an integer of 0 to 50,000, with the proviso that l is not less than m; and

n is an integer of 1 to 100,000.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a reaction sequence for the synthesis of an electroluminescent polymer represented by chemical formula 2.

FIG. 2 is an ¹H-NMR spectrum of the electroluminescent polymer represented by chemical formula 2.

FIG. 3 is a thermal gravimetric analysis (TGA) curve of the electroluminescent polymer represented by chemical formula 2.

FIG. 4 is a differential scanning calorimeter (DSC) curve of the electroluminescent polymer represented by chemical formula 2.

FIG. 5 shows a UV absorption spectrum and a photoluminescence spectrum of the electroluminescent polymer represented by chemical formula 2 in a chloroform solution.

FIG. 6 shows a UV absorption spectrum and a photoluminescence spectrum of the electroluminescent polymer represented by chemical formula 2 in the form of film.

FIG. 7 shows a reaction chain for the synthesis of an electroluminescent polymer represented by chemical formula 3.

FIG. 8 is an ¹H-NMR spectrum of the electroluminescent polymer represented by chemical formula 3.

FIG. 9 is a thermal gravimetric analysis (TGA) curve of the electroluminescent polymer represented by chemical formula 3.

FIG. 10 is a differential scanning calorimeter (DSC) curve of the electroluminescent polymer represented by chemical formula 3.

FIG. 11 shows a UV absorption spectrum and a photoluminescence (PL) spectrum in a chloroform solution of the electroluminescent polymer represented by chemical formula 3.

FIG. 12 shows a UV absorption spectrum and a photoluminescence (PL) spectrum of the electroluminescent polymer represented by chemical formula 3 in the form of film.

FIG. 13 shows a reaction sequence for the synthesis of an electroluminescent polymer represented by chemical formula 4.

FIG. 14 is an ¹H-NMR spectrum of the electroluminescent polymer represented by chemical formula 4.

FIG. 15 is a thermal gravity analysis (TGA) curve of the electroluminescent polymer represented by chemical formula 4.

FIG. 16 is a differential scanning calorimeter (DSC) curve of the electroluminescent polymer represented by chemical formula 4.

FIG. 17 shows a UV absorption spectrum and a photoluminescence (PL) spectrum of the electroluminescent polymer represented by chemical formula 4 in a chloroform solution.

FIG. 18 shows a UV absorption spectrum and a photoluminescence (PL) spectrum of the electroluminescent polymer represented by chemical formula 4 in the form of film.

FIG. 19 shows a reaction sequence for the synthesis of an electroluminescent polymer represented by chemical formula 5.

FIG. 20 is an ¹H-NMR spectrum of the electroluminescent polymer represented by chemical formula 5.

FIG. 21 is a thermal gravity analysis (TGA) curve of the electroluminescent polymer represented by chemical formula 5.

FIG. 22 is a differential scanning calorimeter (DSC) curve of the electroluminescent polymer represented by chemical formula 5.

FIG. 23 shows a UV absorption spectrum and a photoluminescence (PL) spectrum of the electroluminescent polymer represented by chemical formula 5 in a chloroform solution.

FIG. 24 shows a UV absorption spectrum and a photoluminescence (PL) spectrum of the electroluminescent polymer represented by chemical formula 5 in the form of film.

FIG. 25 is a schematic cross-sectional view showing the structure of a typical organic electroluminescent device, comprising substrate/anode/hole transport layer/luminescent layer/electron transport layer/cathode.

FIG. 26 is schematic cross-sectional view showing a structure of an organic electroluminescent device fabricated to measure electroluminescence properties of the electroluminescent polymers prepared in accordance with the present invention.

FIG. 27 shows electroluminescence (EL) spectra of the electroluminescent device fabricated in Example 1 of the present invention.

FIG. 28 is a current-voltage curve of the electroluminescent device fabricated in Example 1 of the present invention.

FIG. 29 is a brightness-voltage curve of the electroluminescent device fabricated in Example 1 of the present invention.

FIG. 30 shows external quantum efficiencies of the electroluminescent device fabricated in Example 1 of the present invention, plotted versus voltages.

FIG. 31 shows power efficiencies and luminescent efficiencies of the electroluminescent device fabricated in Example 1 of the present invention, plotted versus voltages.

FIG. 32 shows electroluminescence (EL) spectra measured from the electroluminescent device fabricated in Example 2 of the present invention.

FIG. 33 is a current-voltage curve of the electroluminescent device fabricated in Example 2 of the present invention.

FIG. 34 is a brightness-voltage curve of the electroluminescent device fabricated in Example 2 of the present invention.

FIG. 35 shows electroluminescence (EL) spectra measured from the electroluminescent device fabricated in Example 3 of the present invention.

FIG. 36 is a current-voltage curve of the electroluminescent device fabricated in Example 3 of the present invention.

FIG. 37 is a brightness-voltage curve of the electroluminescent device fabricated in Example 3 of the present invention.

### DETAILED DESCRIPTION OF THE INVENTION

The organic electroluminescent polymer of the present invention is used as materials for forming a light-emitting layer or a hole transport layer disposed between a pair of electrodes in an EL device.

Since the polymer according to the present invention includes a substituent capable of providing steric hindrance at the alpha position of the vinyl group in the electroluminescent polymer, as shown in the following chemical formula 1, not only is π-stacking between polymer chains suppressed, but also band gaps are increased, allowing emission of blue light of high color purity. In addition, the prevention of intermolecular two- and three-dimensional interference by the introduced bulky substituents leads to reduced extinction of excitons, whereby the organic EL device can emit blue light at high luminous efficiency.

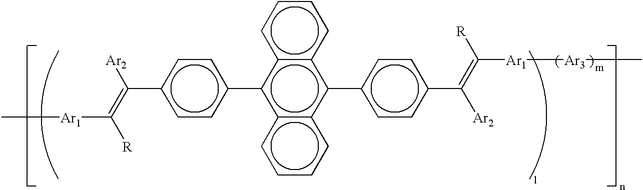

wherein,

Ar₁ and Ar₃ are identical or different, and are selected from the group consisting of:

a non-substituted, C1-C25 alkyl-substituted, or C1-C25 alkoxy-substituted arylene group of 6 to 30 carbon atoms; an arylene group of 10 to 24 atoms having fused aromatic ring such as naphtylene and anthrylene; an arylene group of 6 to 30 carbon atoms, substituted with an alkyl amino group of 1 to 25 carbon atoms or with an aryl amino group of 6 to 30 carbon atoms; a carbazole derivative having an alkyl group of 1 to 25 carbon atoms or an aryl group of 6 to 30 carbon atoms; a fluorenylene group having, at position 9, an alkyl group of 1 to 25 carbon atoms, a polyalkoxide group of 1 to 25 carbon atoms, or an aryl group substituted with an alkyl or alkoxy group of 1 to 25 carbon atoms; a silylene group substituted with an alkyl group of 1 to 25 carbon atoms, an alkoxy group of 1 to 25 carbon atoms, or aryl group of 6 to 30 carbon atoms; and an arylene group of 6 to 30 carbon atoms having a silyl group substituted with an alkyl group of 1 to 25 carbon atoms, an alkoxy group of 1 to 25 carbon atoms or an aryl group of 6 to 30 carbon atoms;

Ar₂ and R are identical or different, and are selected from the group consisting of:

a hydrogen atom; a non-substituted, C1-C25 alkyl-substituted, or C1-C25 alkoxy-substituted aryl group of 6 to 30 carbon atoms; an aryl group of 10 to 24 atoms having fused aromatic ring; an aryl group of 6 to 30 carbon atoms, substituted with an alkyl amino group of 1 to 25 carbon atoms or with an aryl amino group of 6 to 30 carbon atoms; a carbazole derivative having an alkyl group of 1 to 25 carbon atoms or an aryl group of 6 to 30 carbon atoms; a fluorenyl group having, at position 9, an alkyl group of 1 to 25 carbon atoms, a polyalkoxide group of 1 to 25 carbon atoms, or an aryl group substituted with an alkyl or alkoxy group of 1 to 25 carbon atoms; a silyl group substituted with an alkyl group of 1 to 25 carbon atoms, an alkoxy group of 1 to 25 carbon atoms, or aryl group of 6 to 30 carbon atoms; an aryl group of 6 to 30 carbon atoms having a silyl group substituted with an alkyl group of 1 to 25 carbon atoms, an alkoxy group of 1 to 25 carbon atoms or an aryl group of 6 to 30 carbon atoms; and a cyano or fluoro group;

l is an integer of 1 to 100,000 and m is an integer of 0 to 50,000, with the proviso that l is not less than m; and

n is an integer of 1 to 100,000.

Following are examples of the substituents as described above.

Examples of preferred Ar₁ include:

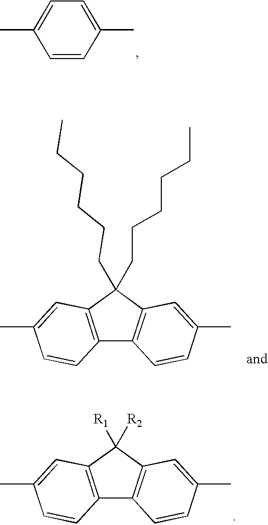

Preferable examples of Ar₂ are found in the group consisting of:

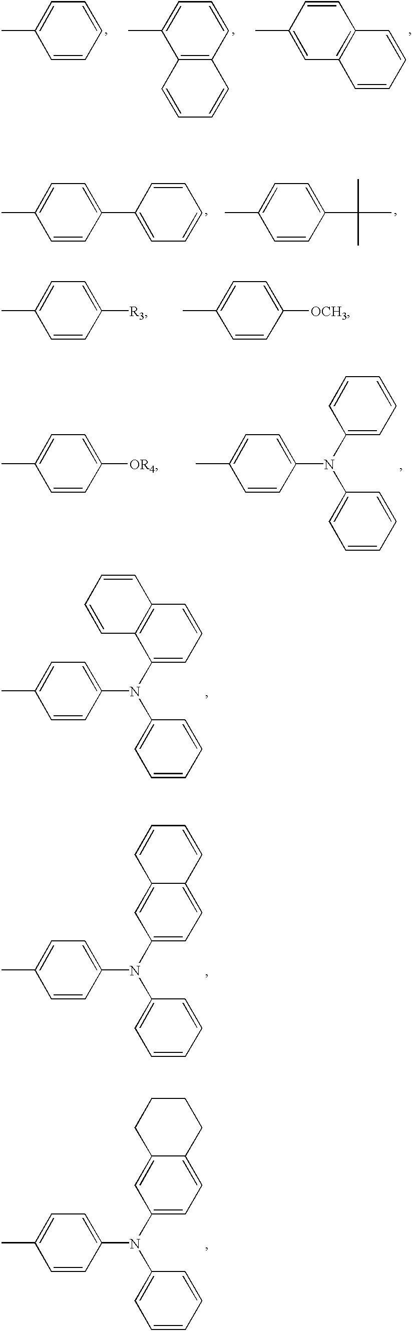

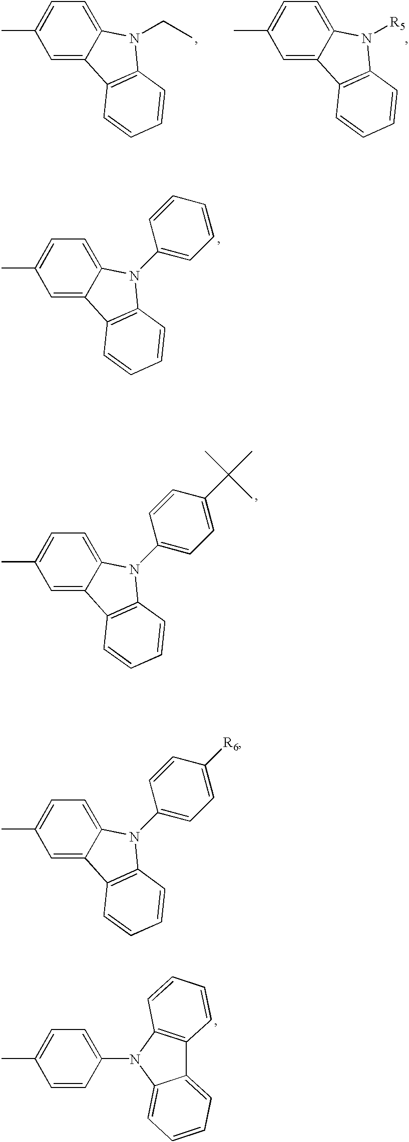

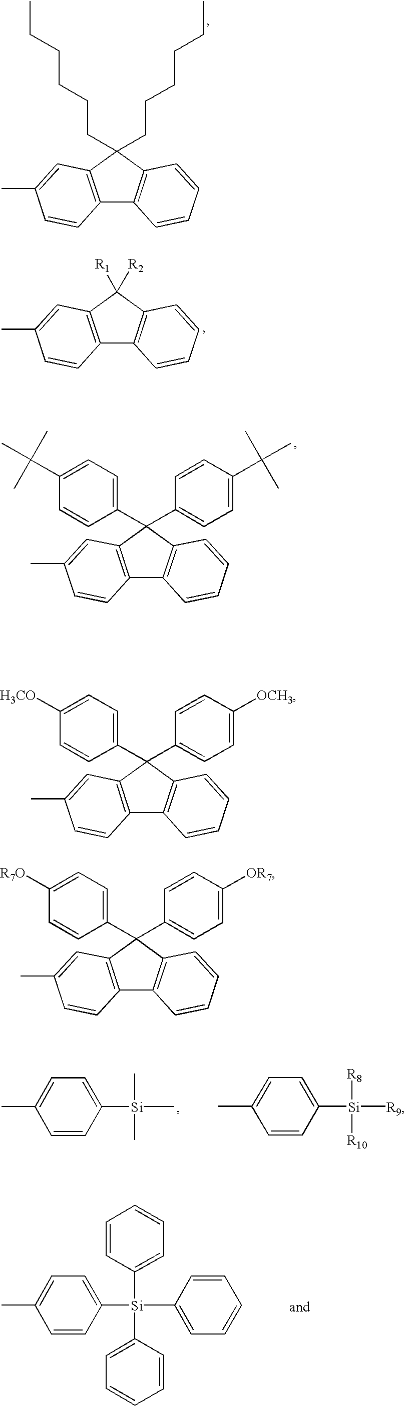

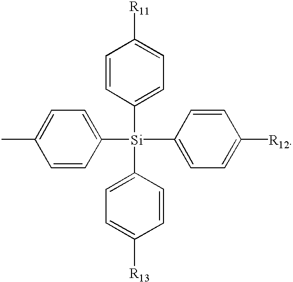

Preferable Ar₃ may be exemplified by:

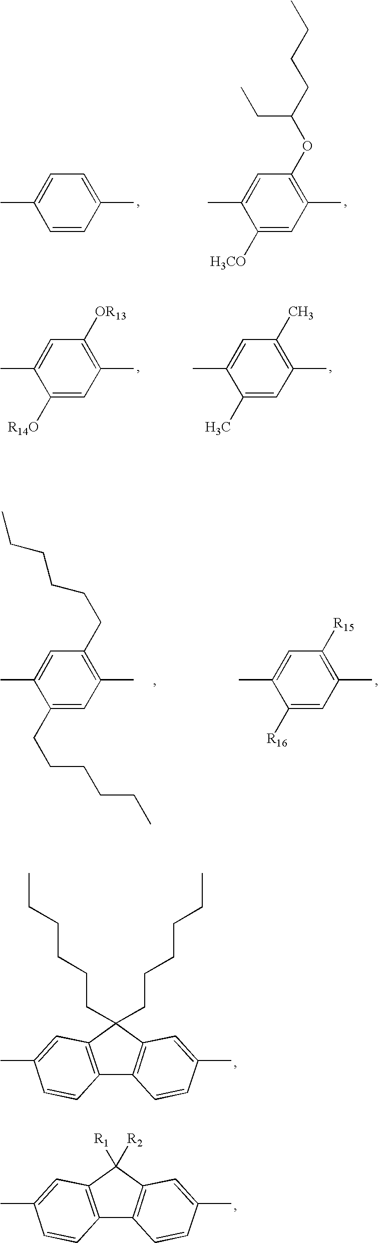

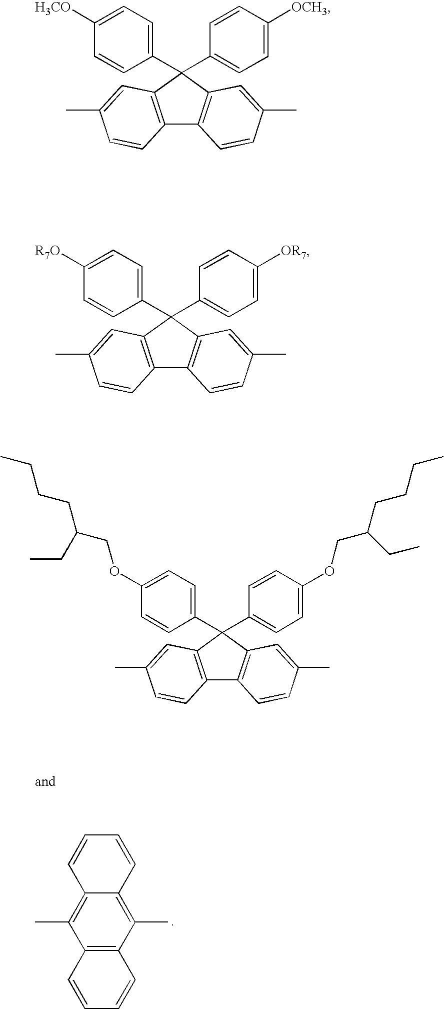

In the exemplified substituents of Ar₁, Ar₂ and Ar₃, R₁ to R₁₇ are identical or different, and are selected from the group consisting of hydrogen, alkyl of 1 to 25 carbon atoms, and aryl of 6 to 30 carbon atoms substituted with an alkyl and/or an alkoxy group of 1 to 25 carbon atoms.

As specific examples of the organic electroluminescent polymer of the chemical formula 1 according to the present invention are represented by the following the chemical formulae 2-5.

The chemical formula 2 conforms to the chemical formula 1, provided that Ar₁ is a phenylene; Ar₂ is a phenyl; Ar₃ is 2-(2′-ethyl)hexyloxy-5-methoxyphenyl (2-2′-ethyl)hexyloxy-5-methoxy phenyl); R is a hydrogen atom; both l and m are 1; and n refers to n₂.

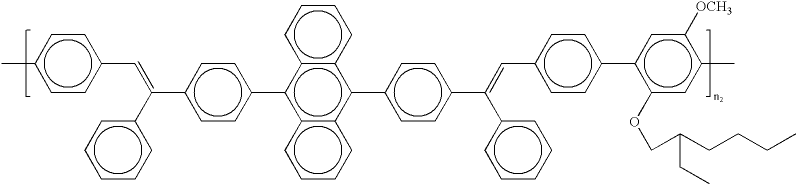

wherein n₂ is an integer of 1 to 100,000.

The chemical formula 3 conforms to the chemical formula 1, provided that Ar₁ is a phenylene; Ar₂ is fluorenyl; R is a hydrogen atom; l is 1; m is 0; and n refers to n₃.

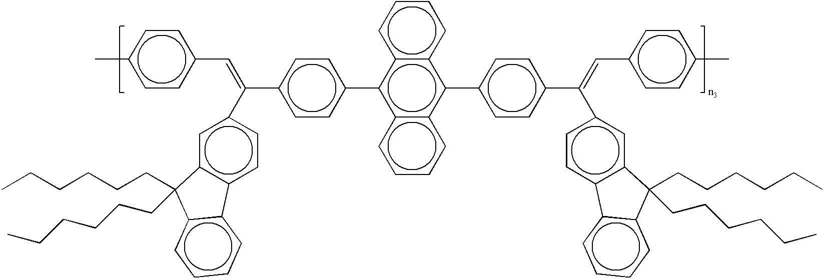

wherein n₃ is an integer of 1 to 100,000.

The chemical formula 4 conforms to the chemical formula 1, provided that Ar₁ is a phenylene; Ar₂ is a 9,9-dihexylfluorenyl; Ar₃ is 2-(2′-ethyl)hexyloxy-5-methoxyphenyl; R is a hydrogen atom; both l and m are 1; and n refers to n₄.

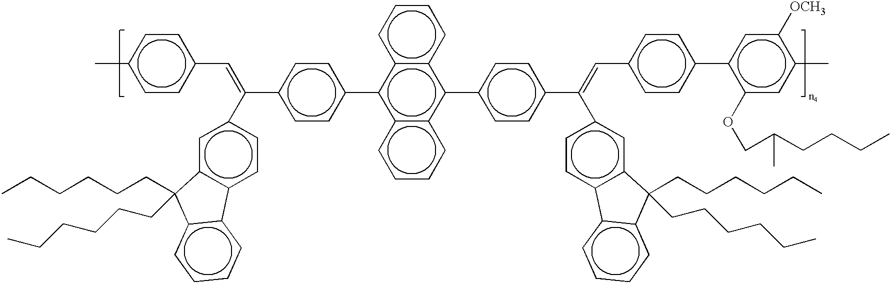

wherein n₄ is an integer of 1 to 100,000.

The chemical formula 5 conforms to the chemical formula 1, provided that Ar₁ is a phenylene; Ar₂ is a 9,9-dihexylfluorenyl; Ar₃ is a 9,9-dihexylfluorenylene; R is a hydrogen atom; both l and m are 1; and n refers to n₅.

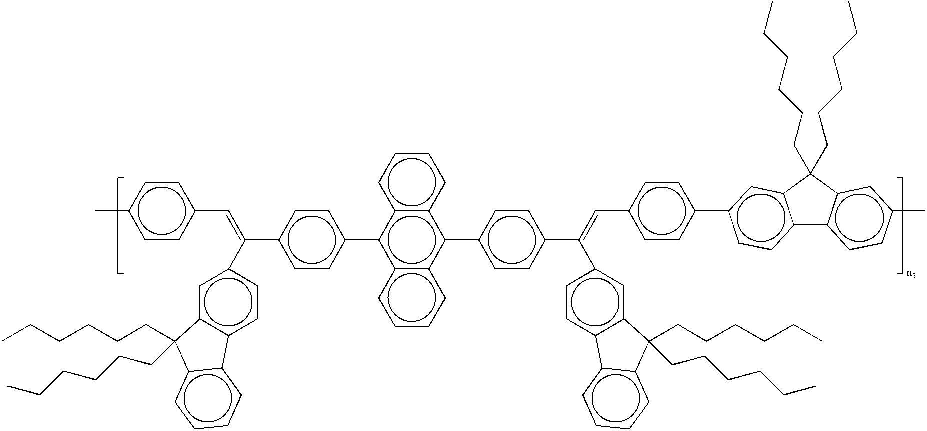

wherein n₅ is an integer of 1 to 100,000.

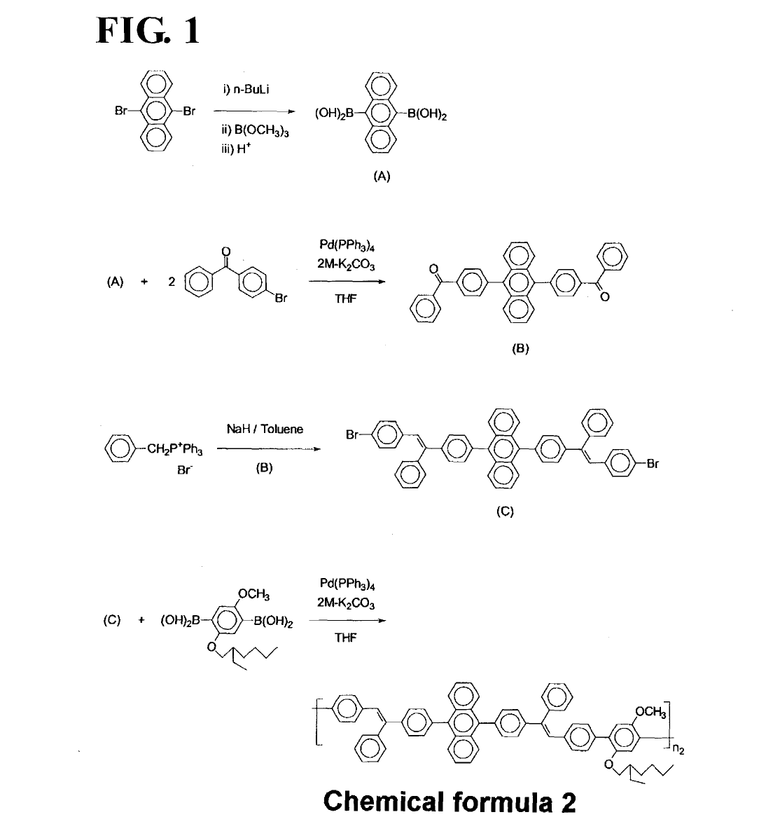

In accordance with the present invention, the organic electroluminescent polymer may be prepared through C-C coupling reaction, such as Suzuki coupling reaction, from monomers obtained by alkylation, Grignard reaction, Suzuki coupling reaction, and/or Wittig reaction, as illustrated in FIGS. 1, 7, 13 and 19. The thus prepared organic electroluminescent polymer, emitting blue light, preferably ranges in number average molecular weight from 500 to 10,000,000 with a molecular weight distribution of 1 to 100.

The electroluminescent polymer, represented by the chemical formula 1, of the present invention is suitable for the formation of light-emitting layer, hole transport layer or electron transport layer of organic EL. Below, a detailed description will be given of the fabrication of organic EL with the electroluminescent polymer.

Firstly, a conductive material is coated on a substrate to form an anode layer. A typical substrate for organic EL may be used. Preferable are glass substrates or transparent plastic substrates thanks to their excellent transparency, surface smoothness, easy handling, and water proofness. Being required to have excellent transparency and electric conductivity, the anode material may be indium tin oxide (ITO), tin oxide (SnO₂), or zinc oxide. Also, a cathode layer is formed at a position opposite to the anode layer. As a cathode material, metal with low work function is suitable, examples of which include lithium, magnesium, aluminum, and an alloy of Al and lithium.

The organic EL device of the present invention may be of the simplest structure of anode/light-emitting layer/cathode or may further comprise a hole transport layer and/or an electron transport layer.

With a preferred thickness of 10 to 10,000 Å, the light-emitting layer can be formed by a known method such as spin coating. If formed, the hole transport layer may be formed on the anode by a vacuum vapor deposition or spin coating, while the electron transport layer may be formed on the light emitting layer by a vacuum vapor deposition or spin coating prior to forming the cathode.

A typically used material may be employed for the formation of the electron transport layer. Alternatively, the electron transport layer may be formed of the compound of the chemical formula 1. Both the hole and the electron transport layer are preferably on the order of 10-10,000 Å in thickness. Materials useful for hole and electron transport layers are not specifically limited. Examples of preferable materials for the hole transport layer include PEDOT:PSS (poly(3,4-ethylenedioxythiophene) doped with poly(styrenesulfonic acid)) and N,N′-bis(3-methylphenyl)-N,N-diphenyl-[1,1′-biphenyl]-4,4′-diamine (TPD). Aluminum trihydroxyquinoline (Alq₃), 2-(4-biphenyl)-5-phenyl-1,3,4-oxadiazole (PBD), 1,3,4-tris[(3-phenyl-6-trifluoromethyl)quinoxaline-2-yl]benzene, and triazole derivatives may be used as materials for the electron transport layer. Both the electron and the hole transport layer serve to efficiently transport carriers into luminescent polymers, thereby increasing the occurrence possibility of light-emitting couplings in the luminescent polymers of the light-emitting layer. Optionally, a hole-blocking layer made of lithium fluoride (LiF) may be formed preferably by vacuum deposition. This layer may control the transporting rate of holes to the light-emitting layer, with the aim of increasing the coupling efficiency of electron-hole.

Finally, material for cathode may be coated on the electron-transport layer or the hole-blocking layer.

The organic electroluminescent device may formed in the order of anode/hole transport layer/light-emitting layer/electron transport layer/cathode as described above, or in the opposite order of cathode/electron transport layer/light-emitting layer/hole transport layer/anode.

Now, the present invention will be described in detail with reference to following examples. These examples however, are intended to illustrate the present invention and should not be construed as limiting the scope of the present invention.

### PREPARATION EXAMPLE 1

### Preparation of Organic Luminescent Polymer of Chemical Formula

This preparation was conducted according to the reaction scheme shown in FIG. 1. First, 15 g of 9,10-dibromoanthracene was dissolved in 300 ml of dry diethylether to which 2.5 equivalents of n-butyllithium was then slowly added at −40° C. After being stirred for 1 hour at room temperature, the solution was cooled to −78° C., then added with 4.6 equivalents of trimethylborate and then stirred for 10 hours at room temperature. The reaction mixture was slowly poured into a mixture of sulfuric acid solution (4N H₂SO₄) and ice, and slowly stirred to give 6.1 g of compound A (Yield 52%).

In 150 ml of THF were dissolved 5.2 g of the compound A and 2.4 equivalents of 4-bromobenzophenone, and the solution was added with 0.133 g (0.6-1 mol %) of tetrakis(triphenylphosphine) palladium and 130 ml (2.5 equivalents) of 2M K₂CO₃. 24 hours of reflux produced 8.5 g of compound B (Yield 81.5%).

In 200 ml of dry THF were 8.0 g of the compound B and 10.5 g of 4-bromobenzyl phosphonate, followed by slow addition of 2.5 equivalents of 1 M potassium t-butoxide (THF solution). The reaction mixture was refluxed for 24 hours to obtain 12 g of compound C (Yield 95%).

0.5 g of the compound C and 1 equivalent of 2-(2′-ethyl)hexyloxy-5-methoxy-1,4-benzenediboronic acid were dissolved in 20 ml of THF and the solution was added with 0.008 g (0.6-1 mol %) of tetrakis(triphenylphosphine) palladium and 5.1 ml (2.5 equivalents) of 2 M K₂CO₃. After 24 hours of reflux, the polymer thus obtained was removed of its terminal bromic moiety by reaction with 0.036 g of benzene boronic acid for 12 hours and then with 0.0094 g of bromobenzene for 12 hours under reflux to produce the polymer of the chemical formula 2.

The polymer of the chemical formula 2 was purified by column chromatography eluting with chloroform and n-hexane. After removal of metal residues by the column chromatography, the purified eluate was subjected to precipitation using a mixture of chloroform as a good solvent and methanol as a non-solvent in a ratio of 1:5. The polymer was dried in a vacuum oven before use in the fabrication of devices.

Purified polymers of the chemical formula 2, obtained by conducting the above procedure three times, were measured for weight average molecular weight, and the results are given in Table 1, below.

TABLE 1

| Experiment Round | 1 | 2 | 3 |
|---|---|---|---|
| Weight Avg. Mw | 33,889 | 21,781 | 30,379 |

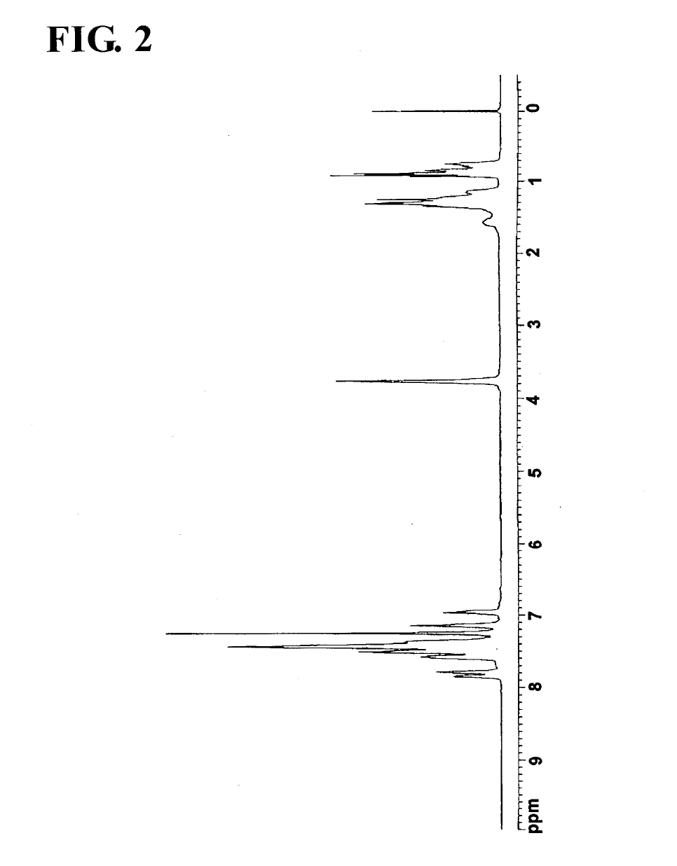

Through ¹H-NMR, the structure of the compound of the chemical formula 2 was identified and the NMR spectrum is shown in FIG. 2: ¹H-NMR(CDCl₃): δ6.9-7.9 (aromatic C—H and vinyl C—H, 38H), δ 3.7-3.8 (—O—CH₂, 2H) δ0.7-1.7 (CH₂ and CH₃, 15H)

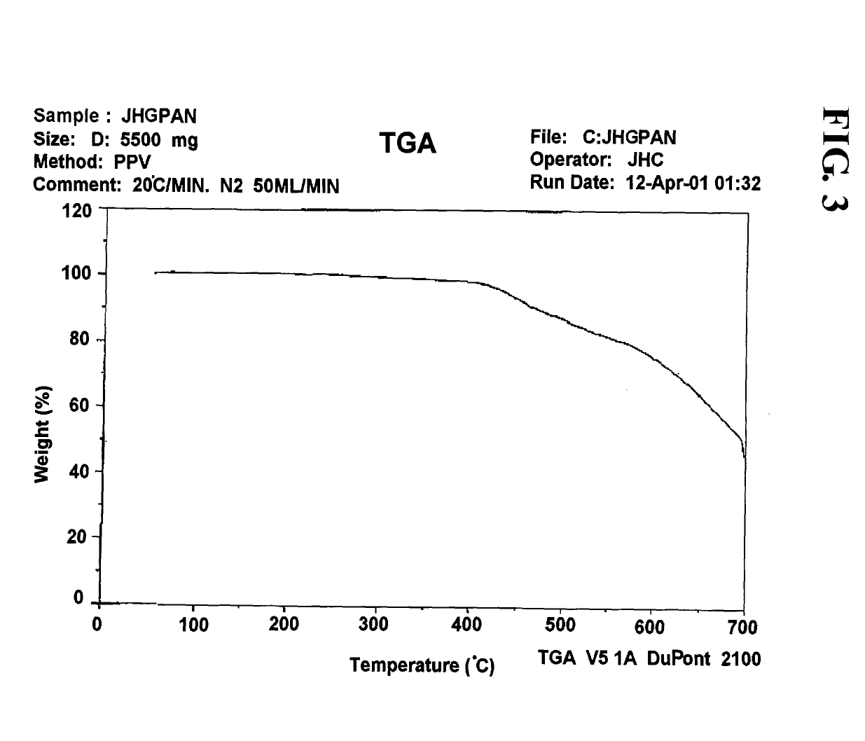

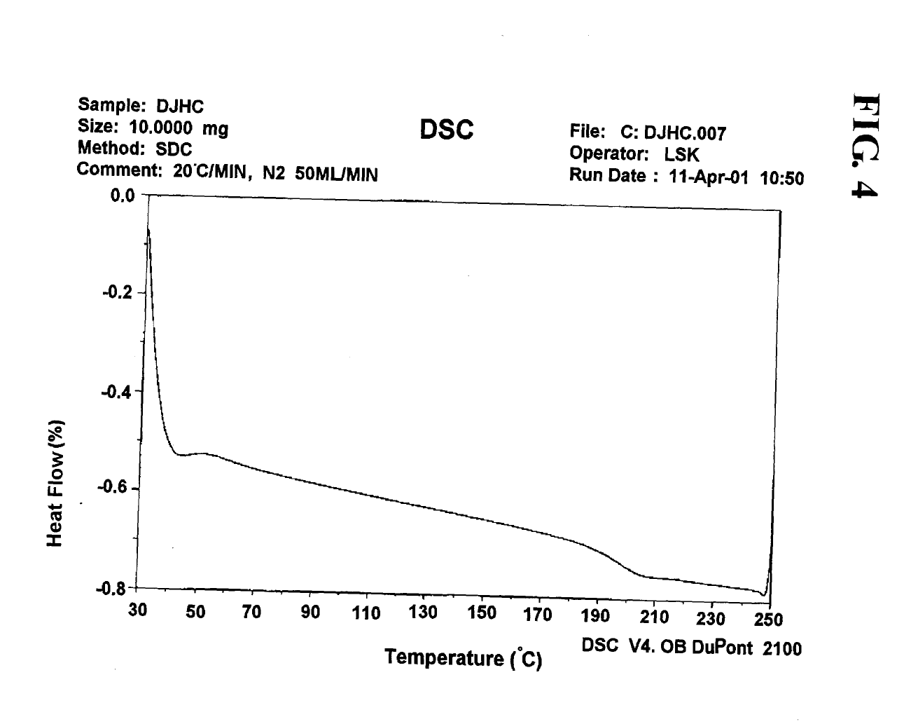

FIG. 3 is a thermal gravimetric analysis curve of the compound, prepared in Preparation Example 1, of the chemical formula 2, showing that the compound is stable even up to 400° C. without thermal decomposition. Its glass transition temperature was 198° C. as measured by differential scanning calorimetry, as shown in FIG. 4.

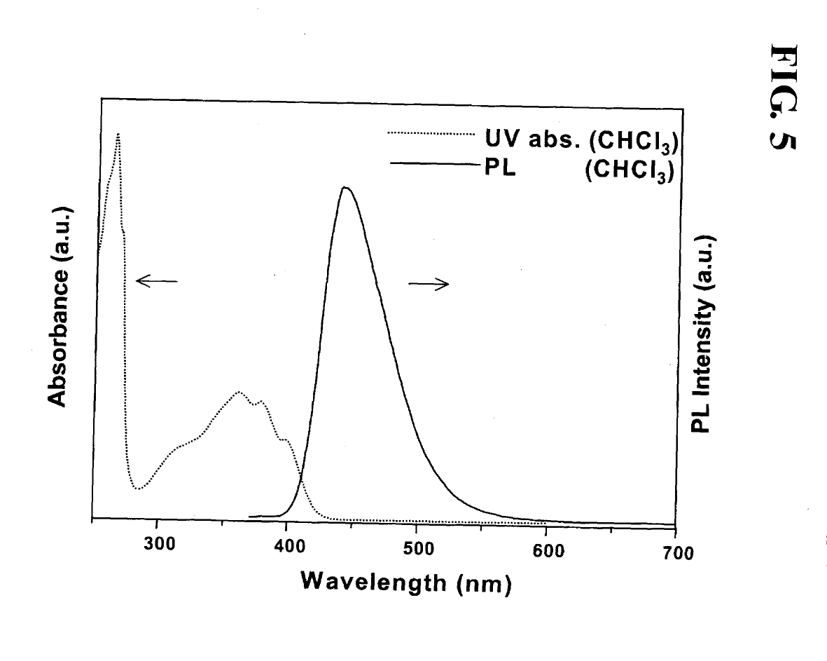

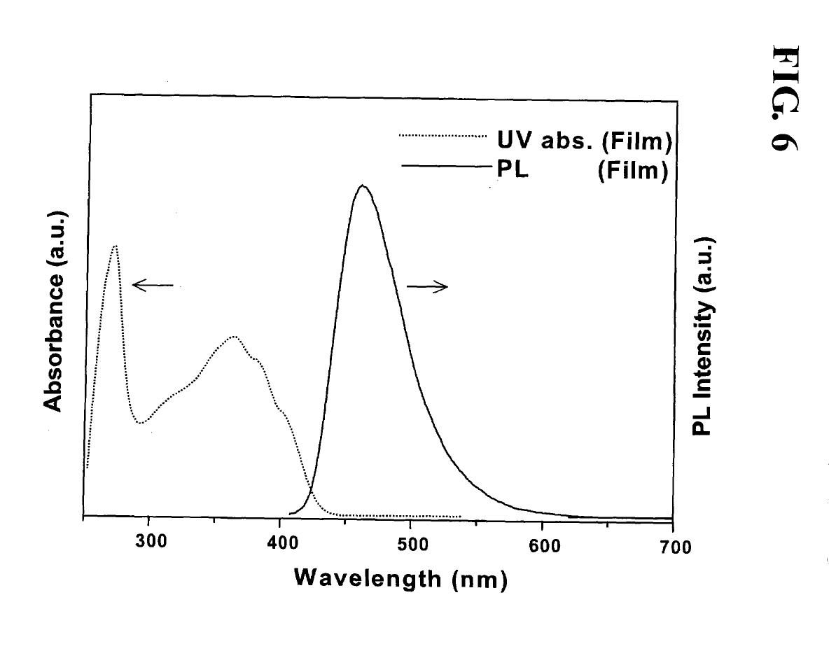

UV-absorption and PL spectra of the compound prepared in Preparation Example 1 are given in FIGS. 5 and 6. As seen in the spectra, maximum peaks were found at 360 nm for UV absorption and at 440 nm for PL when the compound of the chemical formula 2 was measured as being dissolved in chloroform, and at 360 nm for UV absorption and at 460 nm for PL, which is within the range of blue wavelengths, when the compound was measured as being spin coated in the form of thin film.

### PREPARATION EXAMPLE 2

### Preparation of Organic Electroluminescent Polymer of Chemical Formula 3

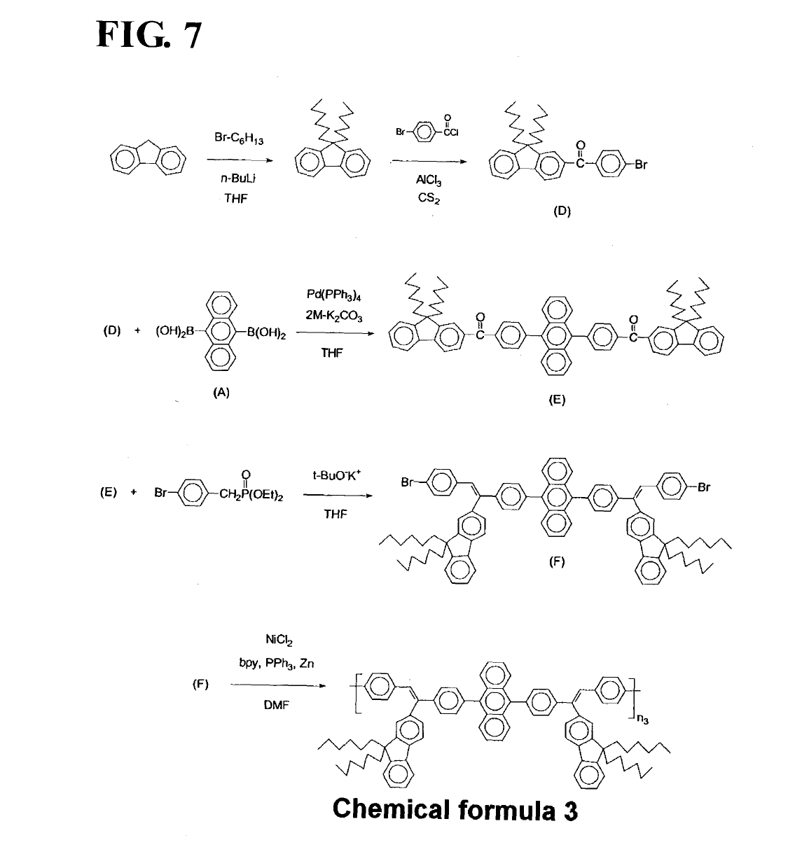

This preparation was conducted according to the reaction scheme shown in FIG. 7. First, 20 g of fluorene was dissolved in 500 ml of dry tetrahydrofuran (THF) to which 1 equivalent of n-butyllithium was then slowly added at −70° C. After being stirred for 30 min at 0° C., the solution was cooled to −70° C. again, then added with 1 equivalent of 1-bromohexane and then reacted at room temperature. This procedure was repeated three times, and the reaction mixture was extracted with n-hexane. Recrystallization in n-hexane at −30° C. produced 28 g of 9,9-dihexylfluorene.

40 g of 9,9-dihexylfluorene was mixed with 20.8 g of aluminum chloride (AlCl₃) and 300 ml of CS2 and the mixture was stirred at 0° C. To the mixture was dropwise added a solution of 26.3 g of 4-bromobenzoylchloride in 80 ml of CS2, followed by reaction for 2 hours. The reaction mixture was poured in a mixture of 2N HCl solution and ice, extracted with ether, and recrystallized in n-hexane to give compound D.

9.34 g of the compound D and 2.0 g of the compound A were added to 25 ml of THF and 20 ml of 2 M K₂CO₃, and reacted for 72 hours in the presence of 0.44 g (0.6-1 mol %) of tetrakis(triphenylphosphine) palladium under reflux.

A solid content was removed from the reaction mixture, washed with ether, refluxed in ethanol, and filtered to produce compound E.

10 g of the compound E and 6.7 g of 4-bromobenzylphosphonate were refluxed in 80 ml of THF while 2.66 g of potassium tert-butoxide was added in three installments. After 24 hours of reaction, the reaction mixture was poured in a mixture of 2N HCl solution and ice. Extraction with ether was followed by column chromatography and recrystallization in hexane to give the compound F.

A mixture of 0.004 g of nickel chloride (NiCl₂), 0.005 g of 2,2′-bipyridine (bpy), 0.16 g of triphenylphosphine (PPh₃) and 0.087 g of zinc powder was purged with nitrogen, added to 5 ml of dry N,N-dimethyl formamide (DMF), and activated by heating. To the mixture was rapidly added 0.6 g of the compound F, followed by reaction at 90° C. for 24 hours. After addition of a trace amount of bromobenzene, reaction was further conducted for an additional 24 hours. The resulting reaction mixture was poured in a mixture of 2N HCl solution and ice, and then extracted with chloroform to give a compound represented by the chemical formula 3.

The polymer of the chemical formula 3 was purified by column chromatography eluting with chloroform and n-hexane. After removal of metal residues by the column chromatography, the purified eluate was subjected to precipitation using a mixture of chloroform as a good solvent and methanol as a non-solvent in a ratio of 1:5. The polymer was dried in a vacuum oven before use in the fabrication of devices.

The purified polymer of the chemical formula 3 was measured for weight average molecular weight, and the result is given in Table 2, below.

TABLE 2

| Experiment Round | 1 |
|---|---|
| Weight Avg. Mw | 4,204 |

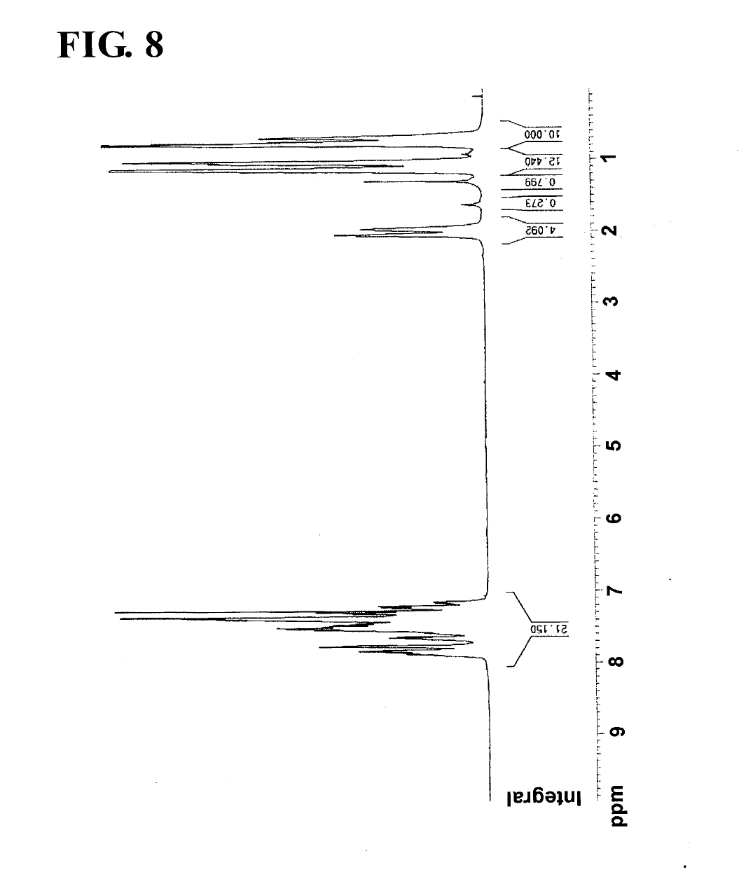

Through ¹H-NMR, the structure of the compound of the chemical formula 3 was identified and the NMR spectrum is shown in FIG. 8.

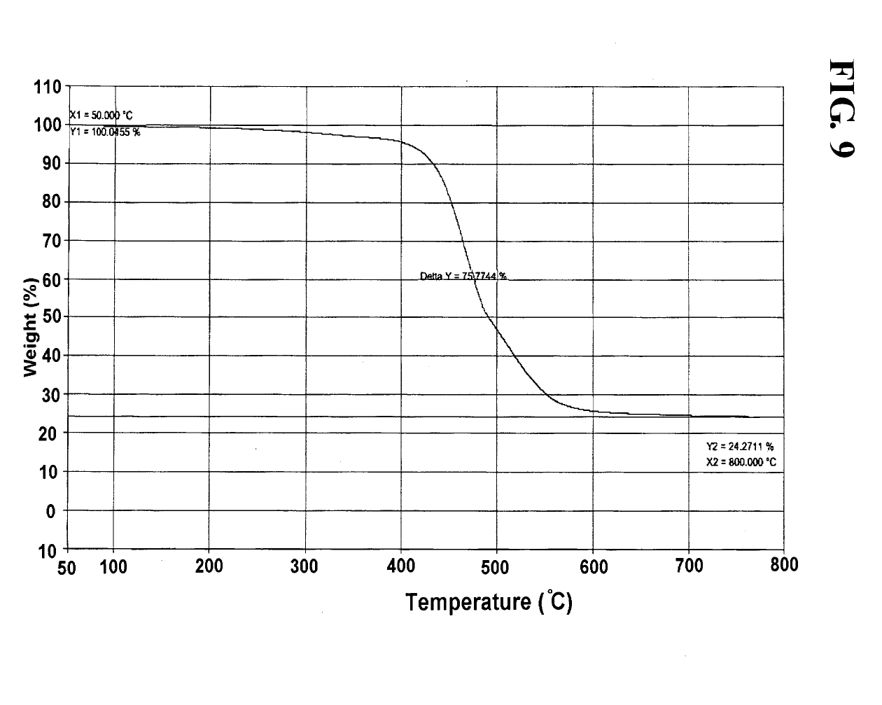

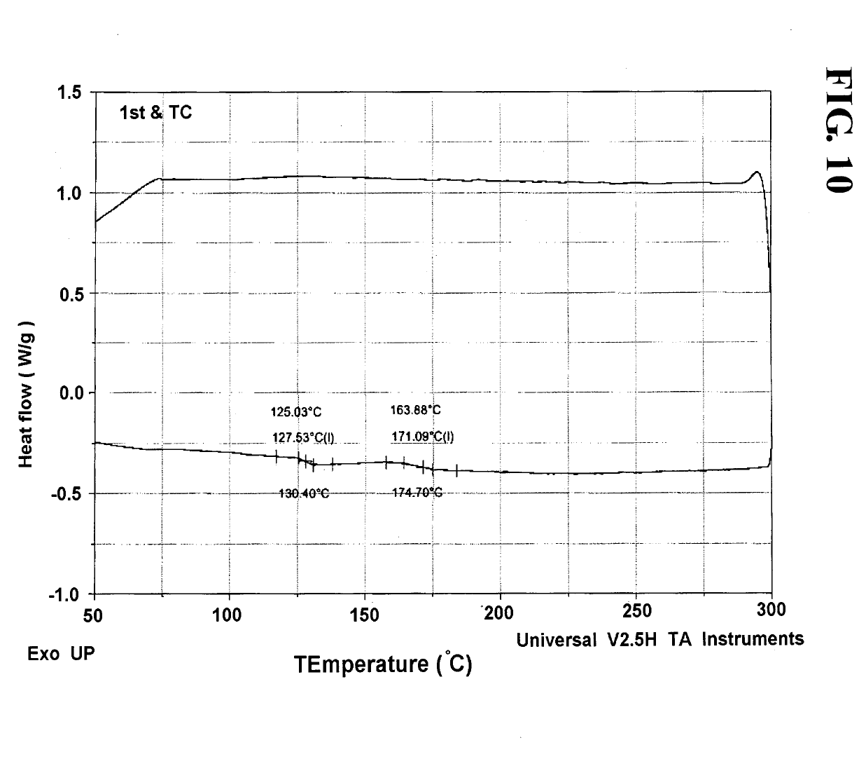

FIG. 9 is a thermal gravimetric analysis curve of the compound, prepared in Preparation Example 2, of the chemical formula 3, showing that the compound is stable even up to 400° C. without thermal decomposition. Its glass transition temperature was 174° C. as measured by differential scanning calorimetry, as shown in FIG. 10.

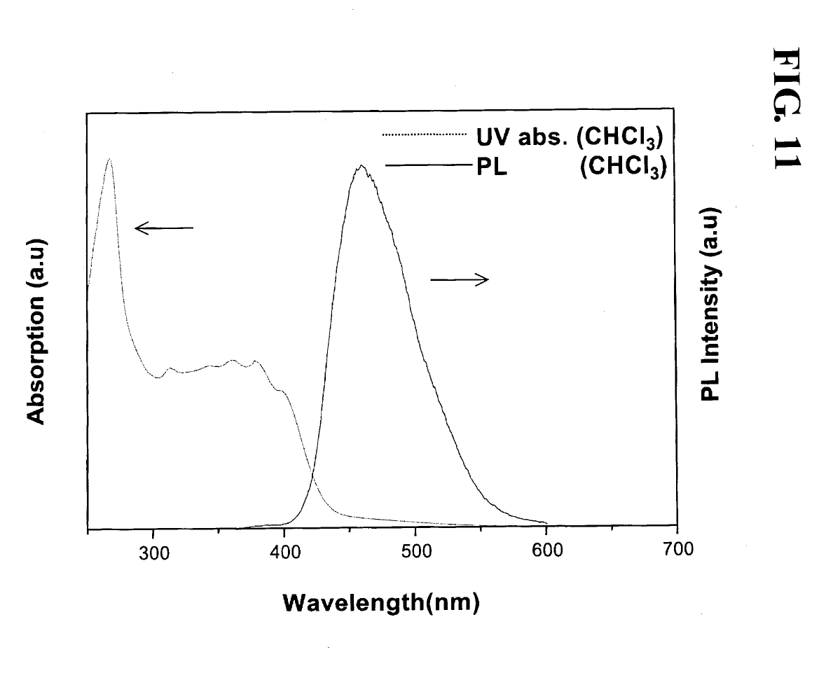

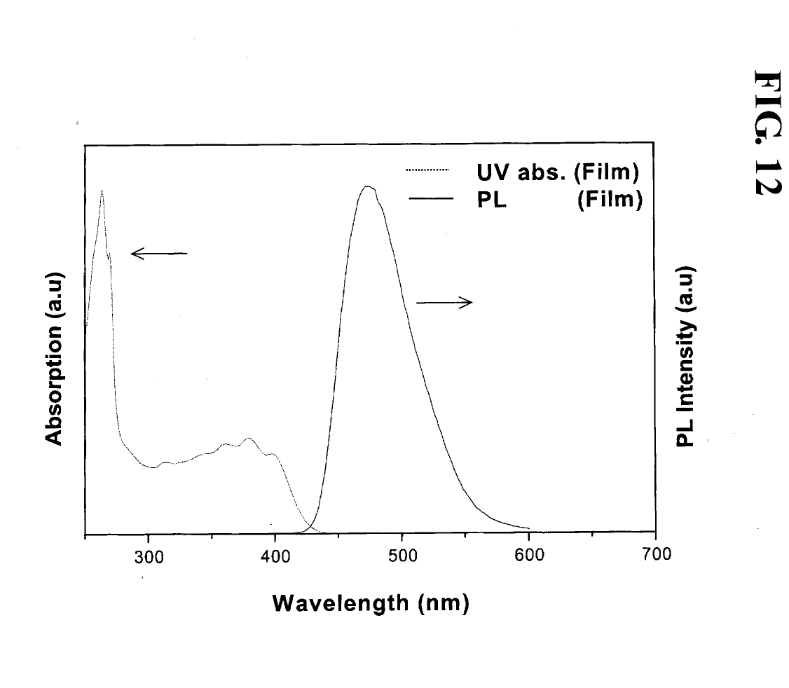

UV-absorption and PL spectra of the compound prepared in Preparation Example 2 are given in FIGS. 11 and 12. As seen in the spectra, maximum peaks were found at 378 nm for UV absorption and at 461 nm for PL when the compound of the chemical formula 3 was measured as being dissolved in chloroform, and at 378 nm for UV absorption and at 475 nm for PL, which is within the range of blue wavelengths, when the compound was measured as being spin coated in the form of thin film.

### PREPARATION EXAMPLE 3

### Preparation of Organic Electroluminescent Polymer of Chemical Formula 4

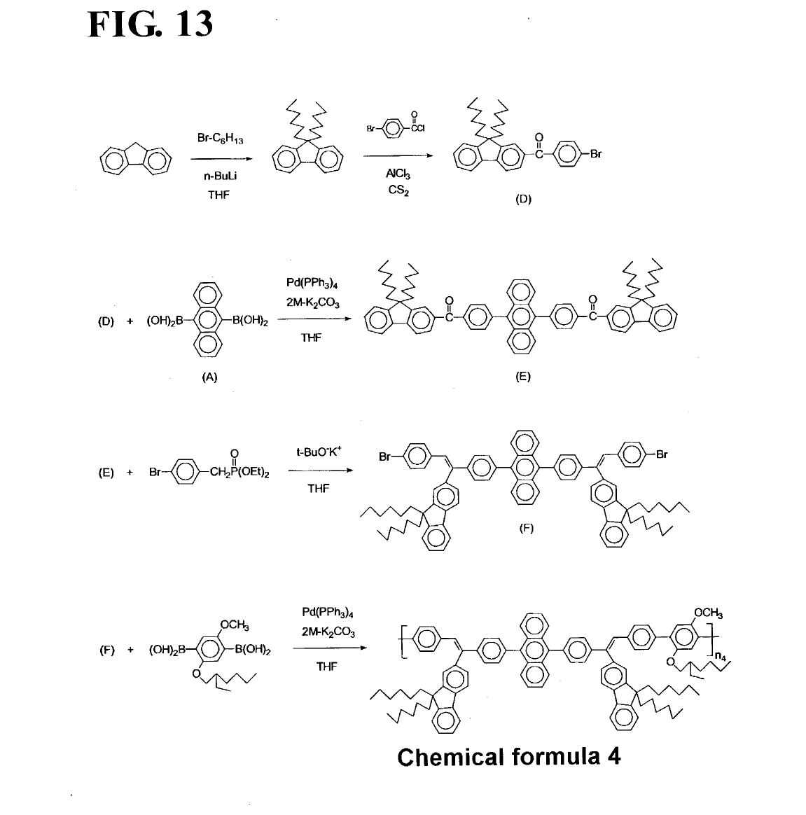

This preparation was conducted according to the reaction scheme shown in FIG. 13. First, 20 g of fluorene was dissolved in 500 ml of dry THF to which 1 equivalent of n-butyllithium was then slowly added at −70° C. After being stirred for 30 min at 0° C., the solution was cooled again to −70° C., then added with 1 equivalent of 1-bromohexane and then reacted at room temperature. This procedure was repeated three times, and the reaction mixture was extracted with n-hexane. Recrystallization in n-hexane at −30° C. produced 28 g of 9,9-dihexylfluorene.

40 g of dihexylfluorene was mixed with 20.8 g of aluminum chloride (AlCl₃) and 300 ml of CS2 and the mixture was stirred at 0° C. To the mixture was dropwise added a solution of 26.3 g of 4-bromobenzoylchloride in 80 ml of CS2, followed by reaction for 2 hours. The reaction mixture was poured in a mixture of 2N HCl solution and ice, extracted with ether, and recrystallized in n-hexane to give compound D.

9.34 g of the compound D and 2.0 g of the compound A were dissolved in 25 ml of THF and 20 ml of 2 M K₂CO₃, and reacted for 72 hours in the presence of 0.44 g (0.6-1 mol %) of tetrakis(triphenylphosphine) palladium under reflux.

A solid content was removed from the reaction mixture, washed with ether, refluxed in ethanol, and filtered to produce compound E.

10 g of the compound E and 6.7 g of 4-bromobenzylphosphonate were refluxed in 80 ml of THF while 2.66 g of potassium tert-butoxide was added in three installments. After 24 hours of reaction, the reaction mixture was poured in a mixture of 2N HCl solution and water. Extraction with ether was followed by column chromatography and recrystallization in hexane to give the compound F.

0.5 g of the compound F and 0.12 g of 2-(2′-ethyl)hexyloxy-5-methoxy-1,4-benzenediboronic acid were dissolved in 15 ml of THF and the solution was added with 0.01 g (0.6-1 mol %) of tetrakis(triphenylphosphine) palladium and 10 ml of 2M K₂CO₃. After 24 hours of reflux, the polymer thus obtained was removed of its terminal bromic moiety by reaction with 0.005 g of benzene boronic acid for 12 hours and then with 0.01 g of bromobenzene for 12 hours under reflux to produce the polymer of the chemical formula 4.

The polymer of the chemical formula 4 was purified by column chromatography eluting with chloroform and n-hexane. After removal of metal residues by the column chromatography, the purified eluate was subjected to precipitation using a mixture of chloroform as a good solvent and methanol as a non-solvent in a ratio of 1:5. The polymer was dried in a vacuum oven before use in the fabrication of devices.

The purified polymer of the chemical formula 4 was measured for weight average molecular weight, and the result is given in Table 3, below.

TABLE 3

| Experiment Round | 1 |
|---|---|
| Weight Avg. Mw | 22,001 |

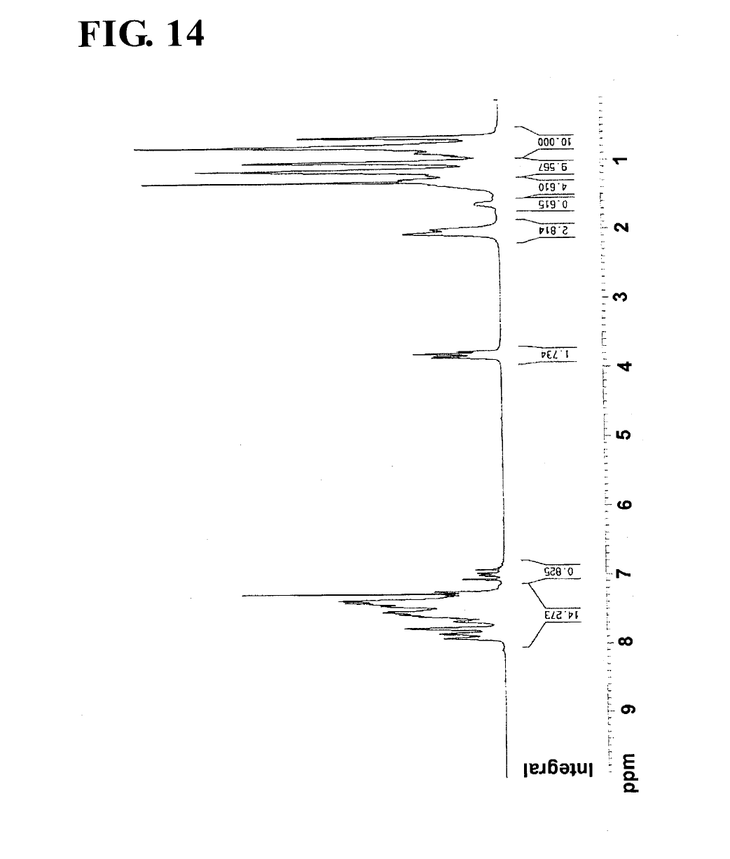

Through ¹H-NMR, the structure of the compound of the chemical formula 4 was identified and the NMR spectrum is shown in FIG. 14.

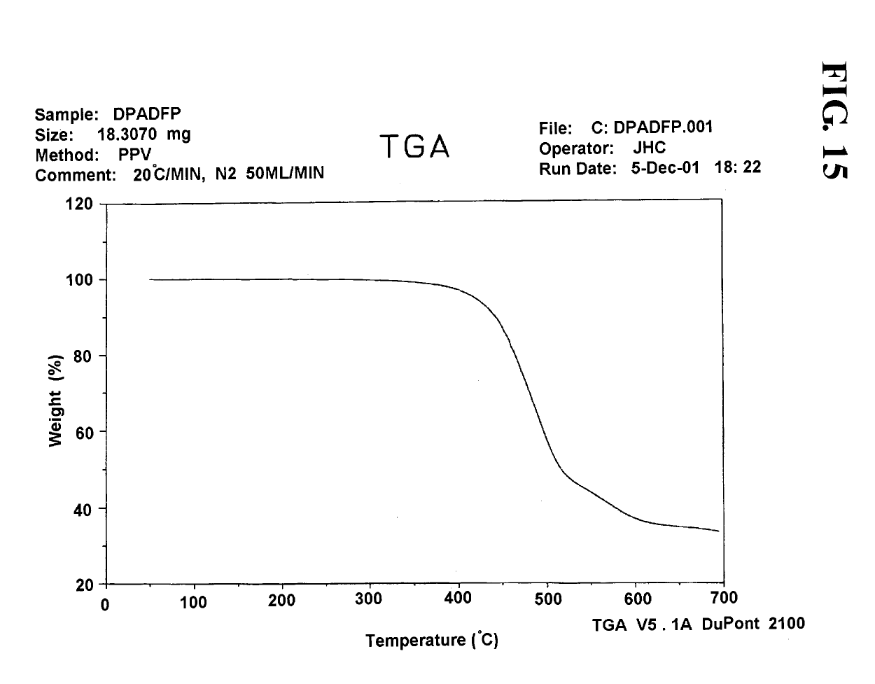

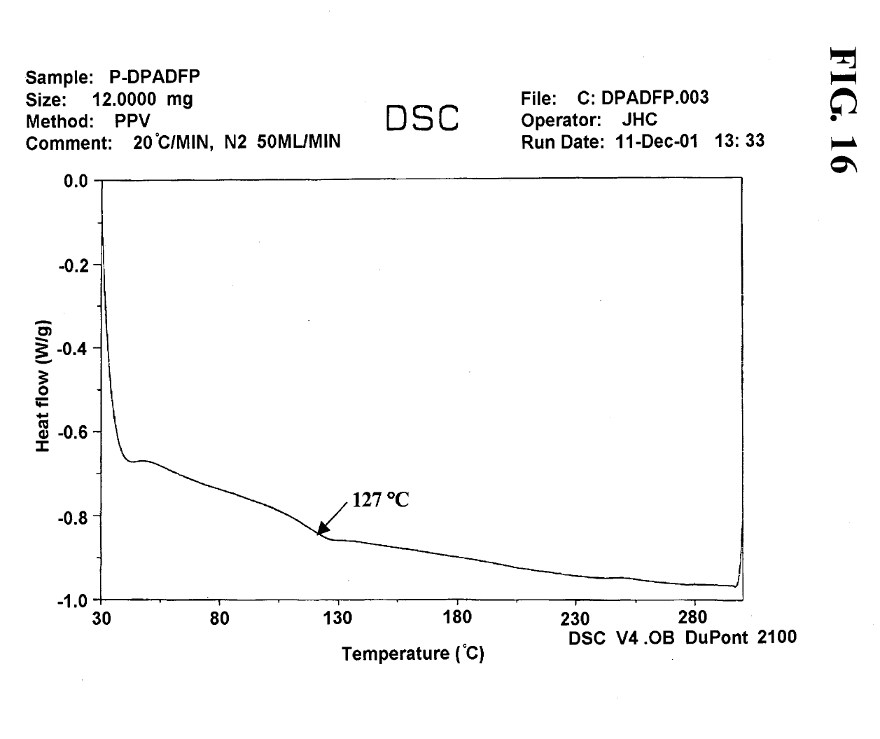

FIG. 15 is a thermal gravimetric analysis curve of the compound, prepared in Preparation Example 3, of the chemical formula 4, showing that the compound is stable even up to 400° C. without thermal decomposition. Its glass transition temperature was 127° C. as measured by differential scanning calorimetry, as shown in FIG. 16.

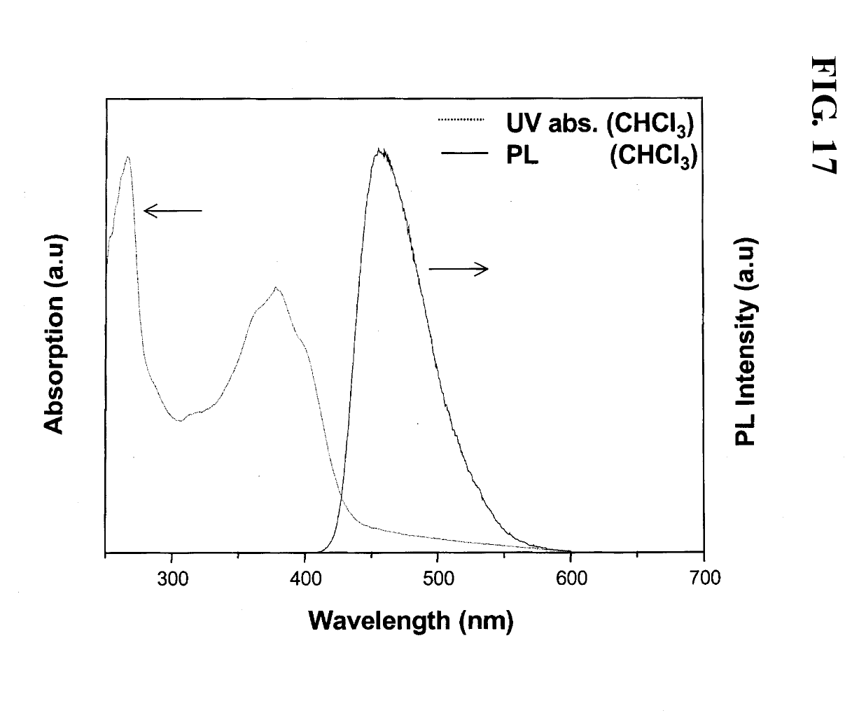

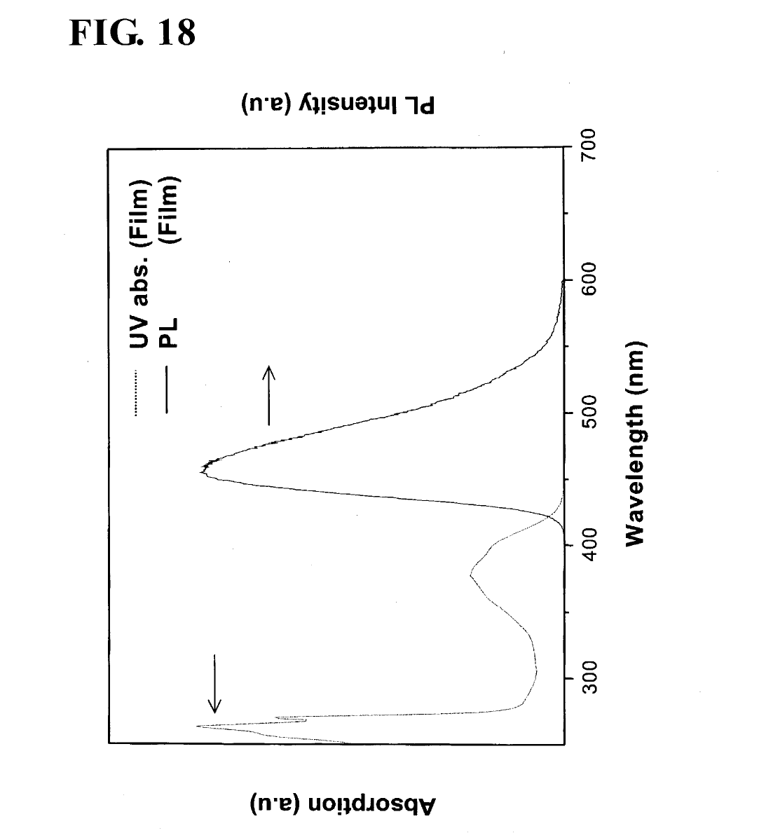

UV-absorption and PL spectra of the compound prepared in Preparation Example 3 are given in FIGS. 17 and 18. As seen in the spectra, maximum peaks were found at 378 nm for UV absorption and at 455.5 nm for PL when the compound of the chemical formula 4 was measured as being dissolved in chloroform, and at 378 nm for UV absorption and at 455 nm for PL, which is within the range of blue wavelengths, when the compound was measured as being spin coated in the form of thin film.

### PREPARATION EXAMPLE 4

### Preparation of Organic Electroluminescent Polymer of Chemical Formula 5

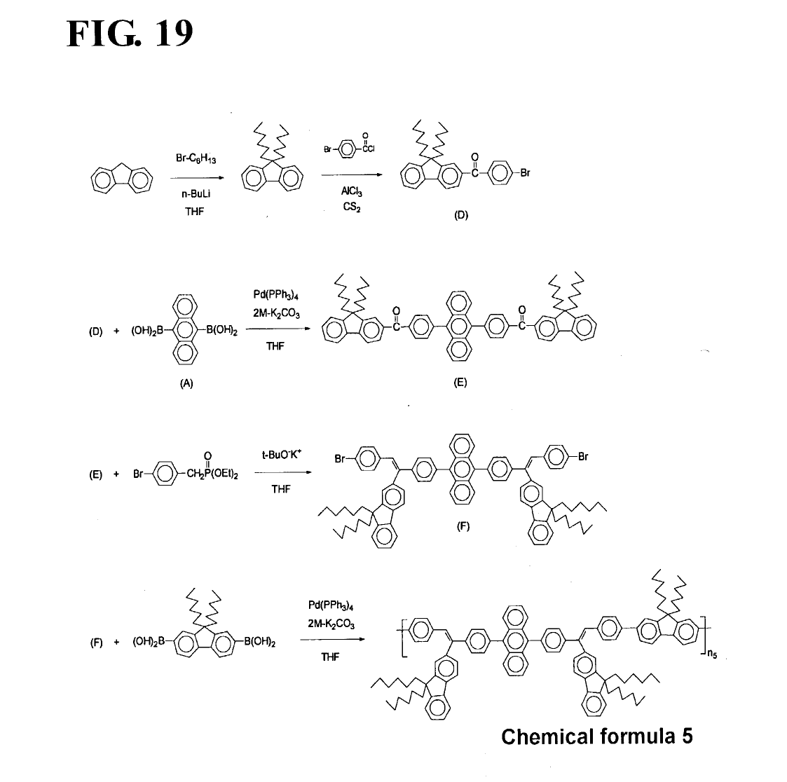

This preparation was conducted according to the reaction scheme shown in FIG. 19. First, 20 g of fluorene was dissolved in 500 ml of dry THF to which 1 equivalent of n-butyllithium was then slowly added at −70° C. After being stirred for 30 min at 0° C., the solution was cooled to −70° C. again, then added with 1 equivalent of 1-bromohexane and then reacted at room temperature. This procedure was repeated three times, and the reaction mixture was extracted with n-hexane. Recrystallization in n-hexane at −30° C. produced 28 g of 9,9-dihexylfluorene.

40 g of dihexylfluorene was mixed with 20.8 g of aluminum chloride (AlCl₃) and 300 ml of CS2, and the mixture was stirred at 0° C. To the mixture was dropwise added a solution of 26.3 g of 4-bromobenzoylchloride in 80 ml of CS2, followed by reaction for 2 hours. The reaction mixture was poured in a mixture of 2N HCl solution and ice, extracted with ether, and recrystallized in n-hexane to give compound D.

9.34 g of the compound D and 2.0 g of the compound A were dissolved in 25 ml of THF and 20 ml of 2M K₂CO₃, and reacted for 72 hours in the presence of 0.44 g (0.6-1 mol %) of tetrakis(triphenylphosphine) palladium under reflux.

A solid content was removed from the reaction mixture, washed with ether, refluxed in ethanol, and filtered to produce compound E.

10 g of the compound E and 6.7 g of 4-bromobenzylphosphonate were refluxed in 80 ml of THF while 2.66 g of potassium tert-butoxide was added in three installments. After 24 hours of reaction, the reaction mixture was poured in a mixture of 2N HCl solution and ice. Extraction with ether was followed by column chromatography and recrystallization in hexane to give the compound F.

0.5 g of the compound F was dissolved, along with 0.16 g of 9,9-dihexylfluorene diboronic acid, in 15 ml of THF and the solution was added with 0.01 g (0.6-1 mol %) of tetrakis(triphenylphosphine) palladium and 10 ml of 2M K₂CO₃. After 24 hours of reflux, the polymer thus obtained was removed of its terminal bromic moiety by reaction with 0.005 g of benzene boronic acid for 12 hours and then with 0.01 g of bromobenzene for 12 hours under reflux to produce the polymer of the chemical formula 5.

The polymer of the chemical formula 5 was purified by column chromatography eluting with chloroform and n-hexane. After removal of metal residues by the column chromatography, the purified eluate was subjected to precipitation using a mixture of chloroform as a good solvent and methanol as a non-solvent in a ratio of 1:5. The polymer was dried in a vacuum oven before use in the fabrication of devices.

The purified polymer of the chemical formula 5 was measured for weight average molecular weight, and the result is given in Table 4, below.

TABLE 4

| Experiment Round | 1 |
|---|---|
| Weight Avg. Mw | 21,695 |

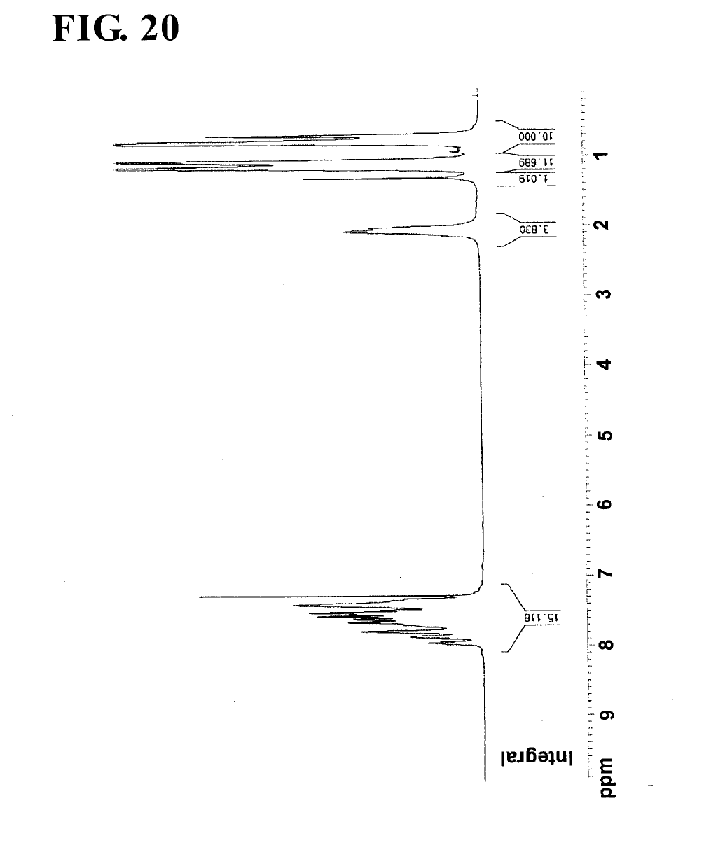

Through ¹H-NMR, the structure of the compound of the chemical formula 5 was identified for structure and the NMR spectrum is shown in FIG. 20.

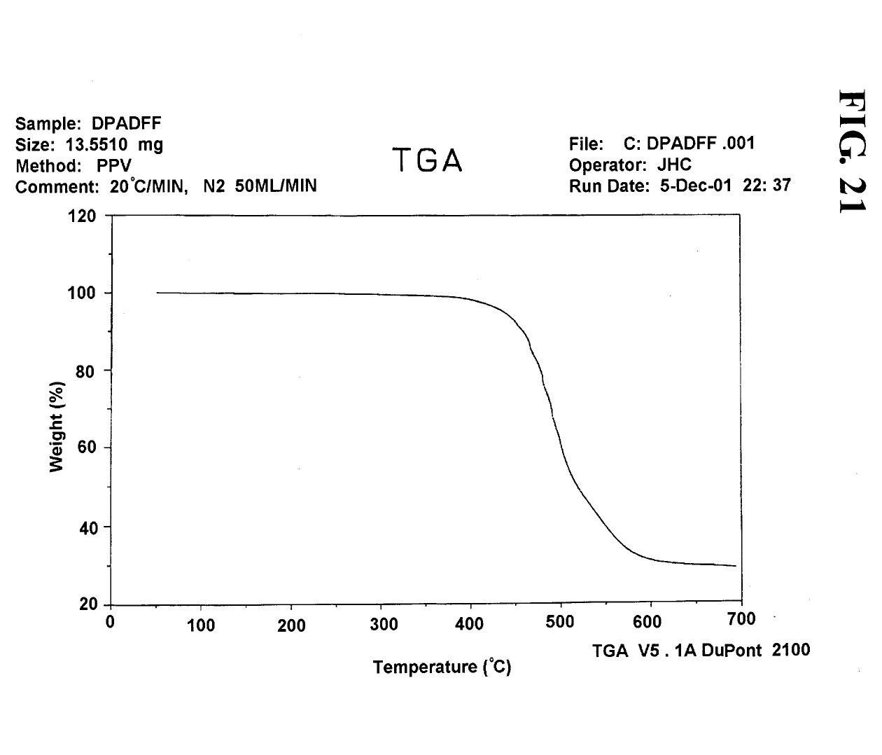

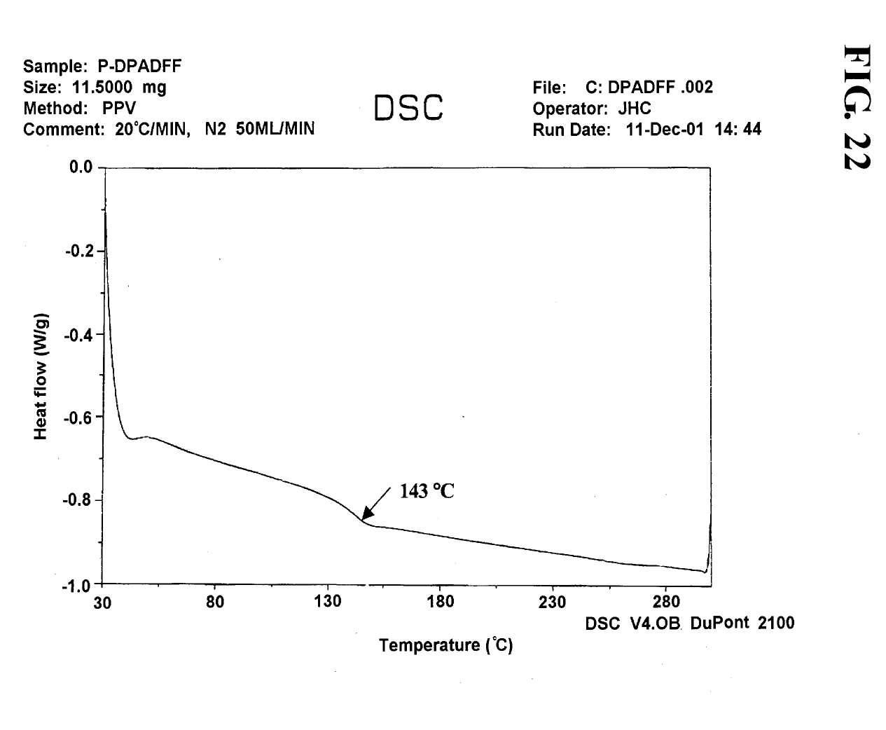

FIG. 21 is a thermal gravimetric analysis curve of the compound, prepared in Preparation Example 4, of the chemical formula 5, showing that the compound is stable even up to 400° C. without thermal decomposition. Its glass transition temperature was 143° C. as measured by differential scanning calorimetry, as shown in FIG. 22.

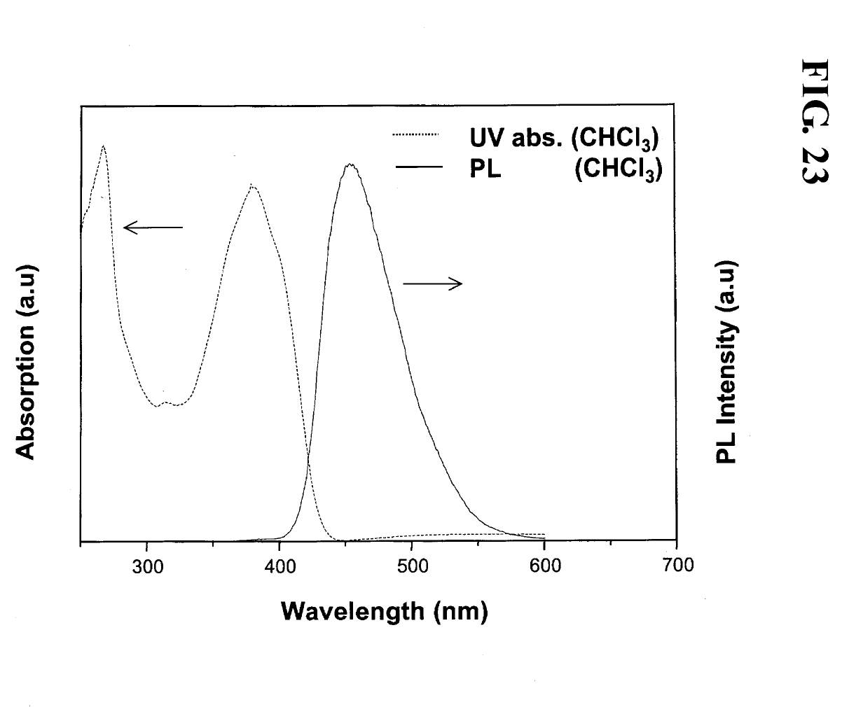

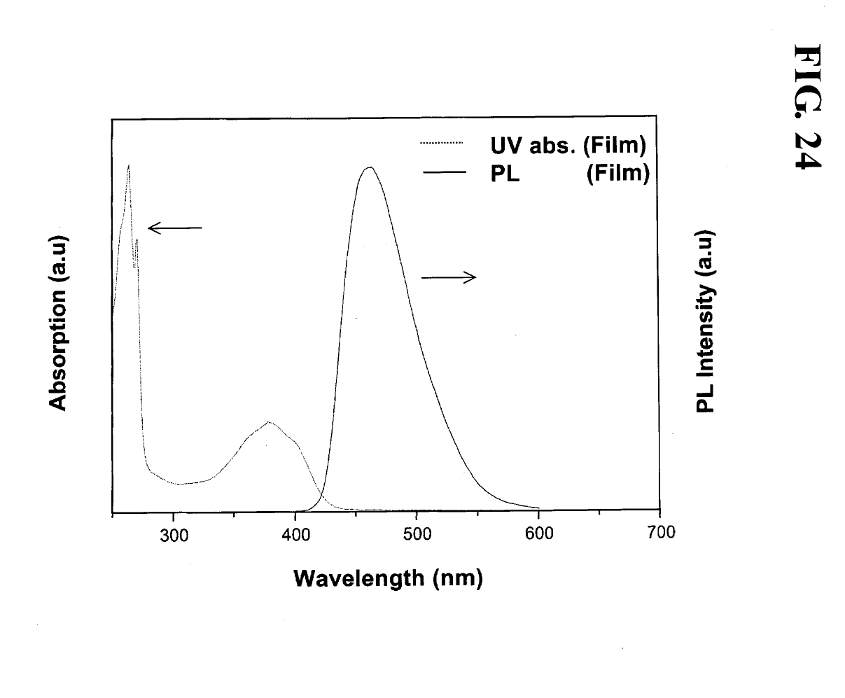

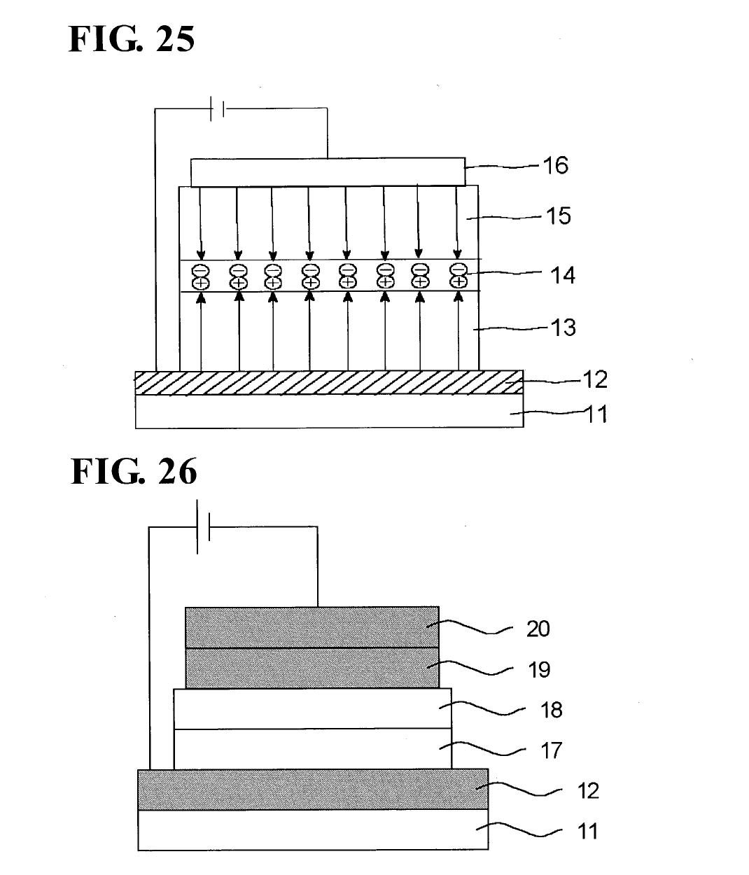

UV-absorption and PL spectra of the compound prepared in Preparation Example 3 are given in FIGS. 23 and 24. As seen in the spectra, maximum peaks were found at 378 nm for UV absorption and at 456 nm for PL when the compound of the chemical formula 5 was measured as being dissolved in chloroform, and at 378 nm for UV absorption and at 462.5 nm for PL, which is within the range of blue wavelengths, when the compound was measured as being spin coated in the form of thin film.

### EXAMPLE 1

On a glass coated with a pattern of ITO, PEDOT:PSS was spin-coated to a thickness of 300 Å to form a hole transport layer, and dried at 100° C. for 1 hour in a vacuum oven. Again, a solution of the compound of the chemical formula 2 in chlorobenzene was spin coated to a thickness of 700-900 Å on the hole transport layer to form a light-emitting layer, followed by drying it at 100° C. for 1 hour in a vacuum oven. After vacuum deposition of LiF (lithium fluoride) to a thickness of 20 Å, aluminum was vacuum deposited to a thickness of 700 Å to form an anode. The organic EL device thus obtained had the structure of FIG. 26.

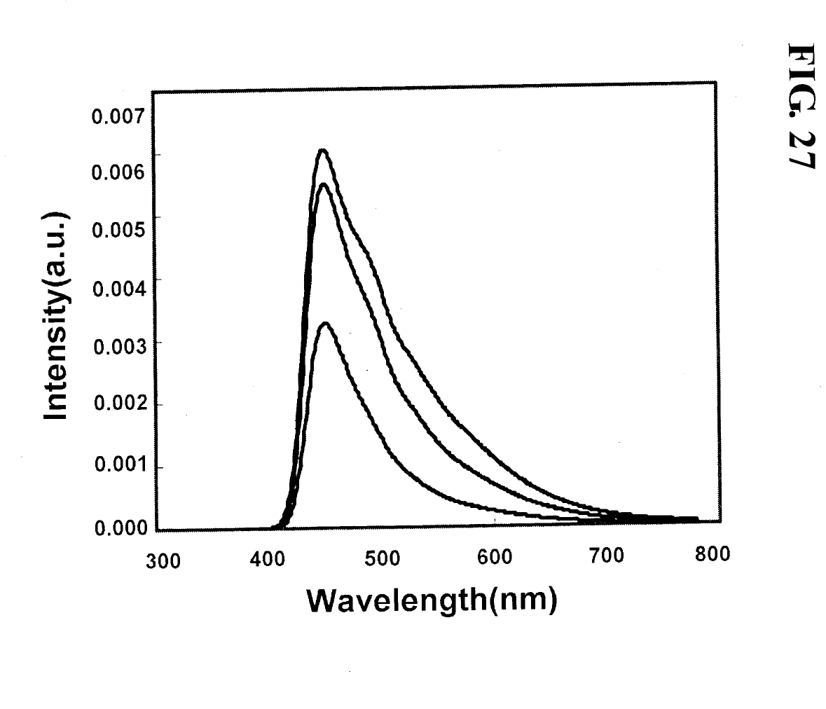

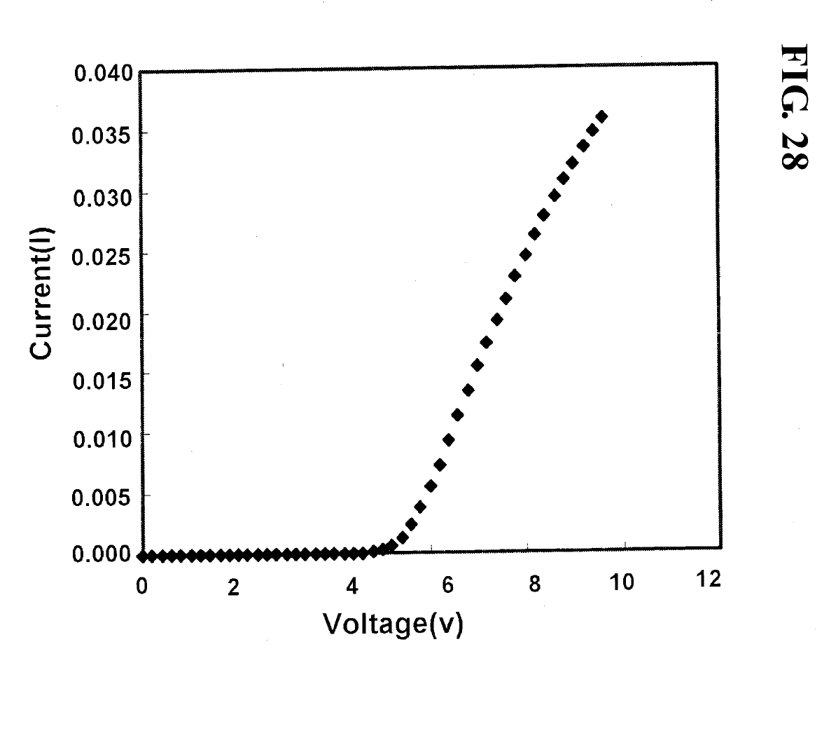

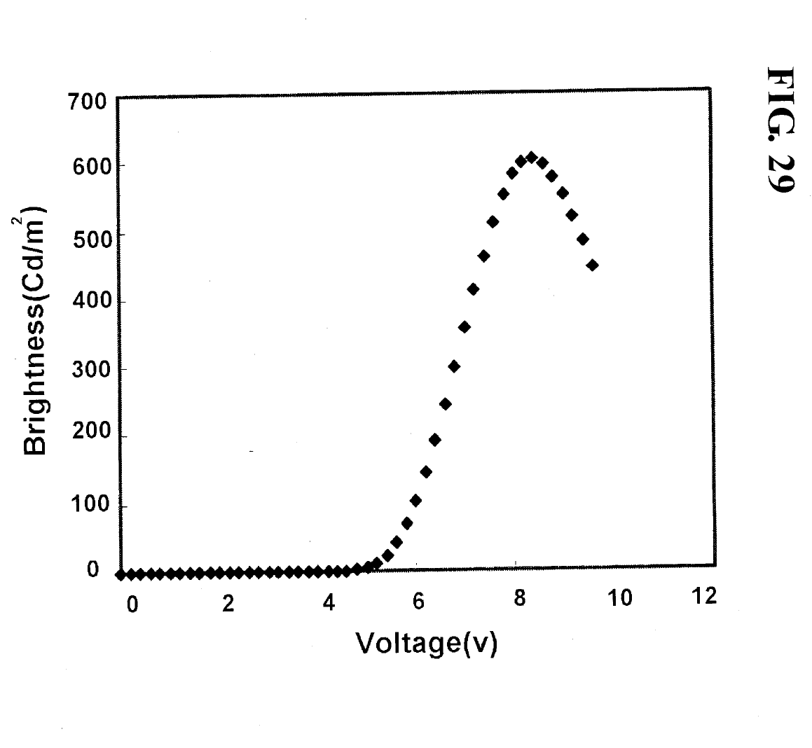

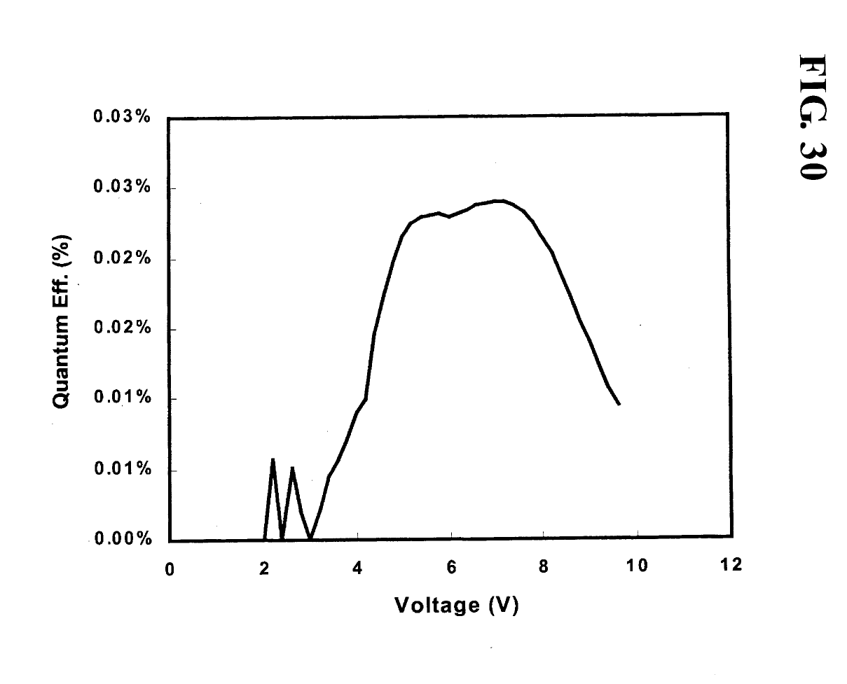

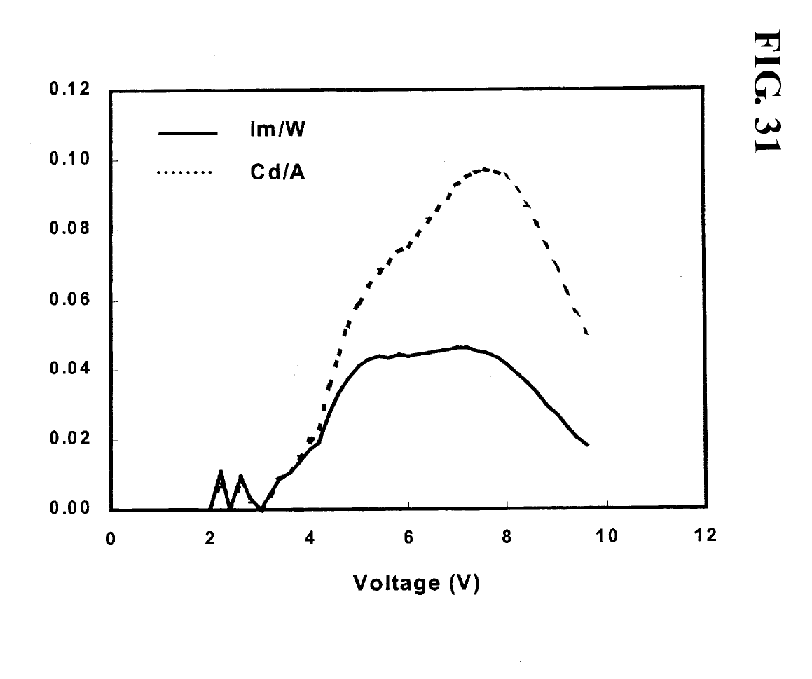

A measurement was made of the EL spectrum and current-voltage, luminance-voltage, efficiency, and color properties of the organic EL device, and the results are given in Table 5, below, and in FIGS. 27 to 31.

TABLE 5

| Test Item | Result |
|---|---|
| Turn-On Voltage( V) | 5.0 |
| Max. Brightness (Cd/m²) | 604 |
| Efficiency | |
| lm/W | 0.046 |
| Cd/A | 0.095 |
| Color | Blue (451 nm) |
| CIE | |
| Coordinate | |
| X | 0.18 |
| Y | 0.23 |

As apparent from the results, the compound of the chemical formula 2, prepared in Preparation Example 1, is a polymer which can emit blue light at relatively low turn-on voltage compared to the conventional compounds, and shows a color purity approximate to the standard blue (NTSC blue).

### EXAMPLE 2

The procedure of Example 1 was repeated, except that the compound of the chemical formula 4, prepared in Preparation Example 3, was used.

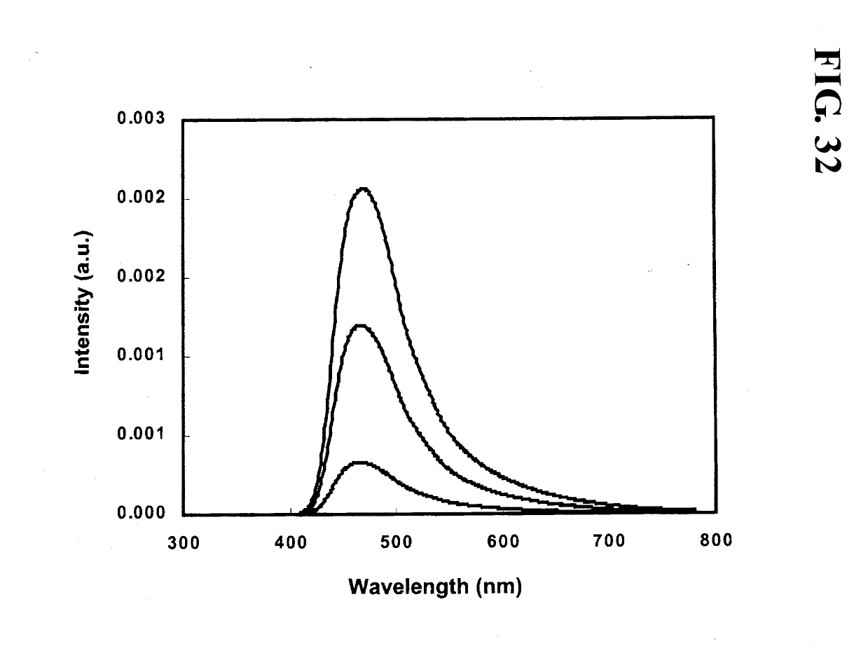

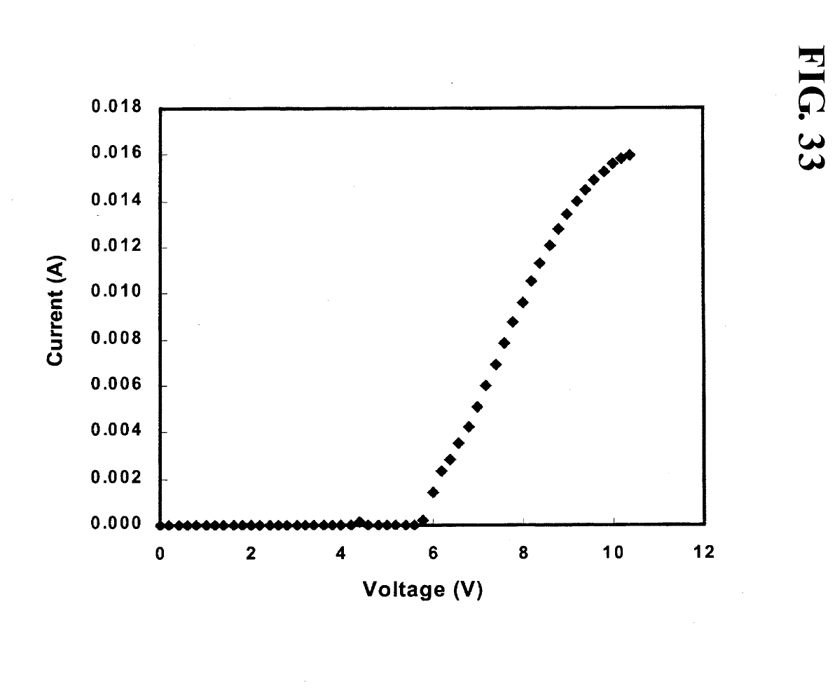

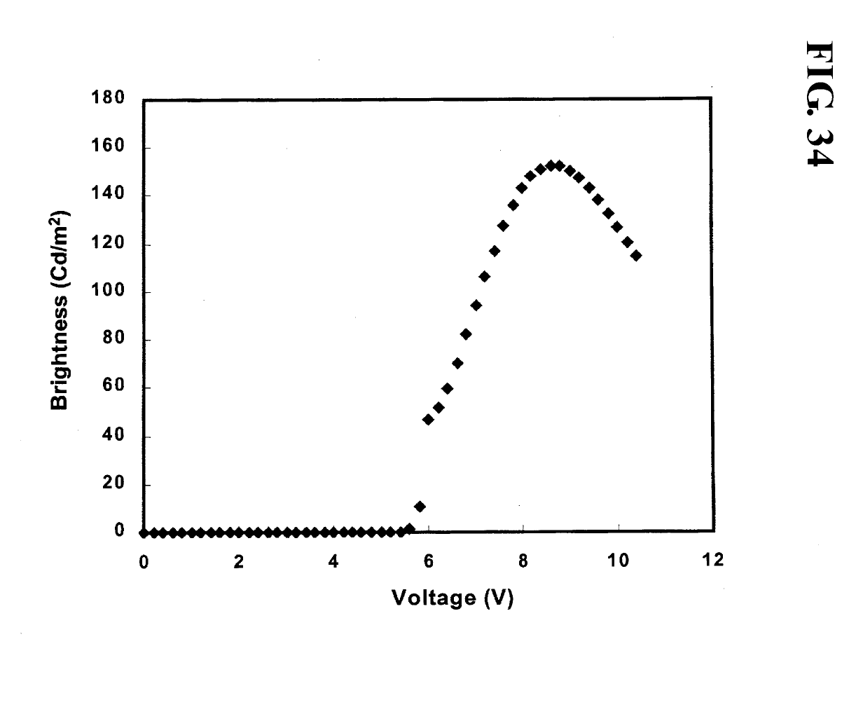

The organic EL device was evaluated for EL spectrum, current-voltage, luminance-voltage, efficiency and color properties, and the results are given in Table 6, below, and in FIGS. 32 to 34.

TABLE 6

| Test Item | Result |
|---|---|
| Turn-On Voltage (V) | 5.8 |
| Max. Brightness (Cd/m²) | 152.5 |
| Color | Blue (466 nm) |
| CIE | |
| Coordinate | |
| X | 0.18 |
| Y | 0.24 |

As apparent from the results, the compound of the chemical formula 4, prepared in Preparation Example 3, is a polymer which can emit blue light at a relatively low turn-on voltage compared to the conventional compounds, and shows a color purity approximate to the standard blue (NTSC blue).

### EXAMPLE 3

The procedure of Example 1 was repeated, except that the compound of the chemical formula 5, prepared in Preparation Example 4, was used.

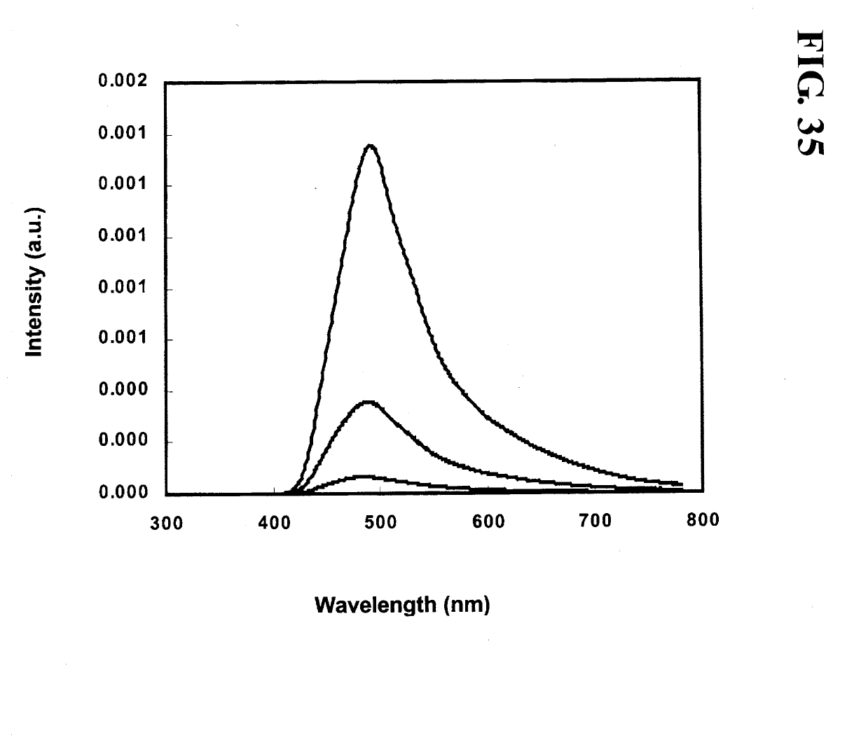

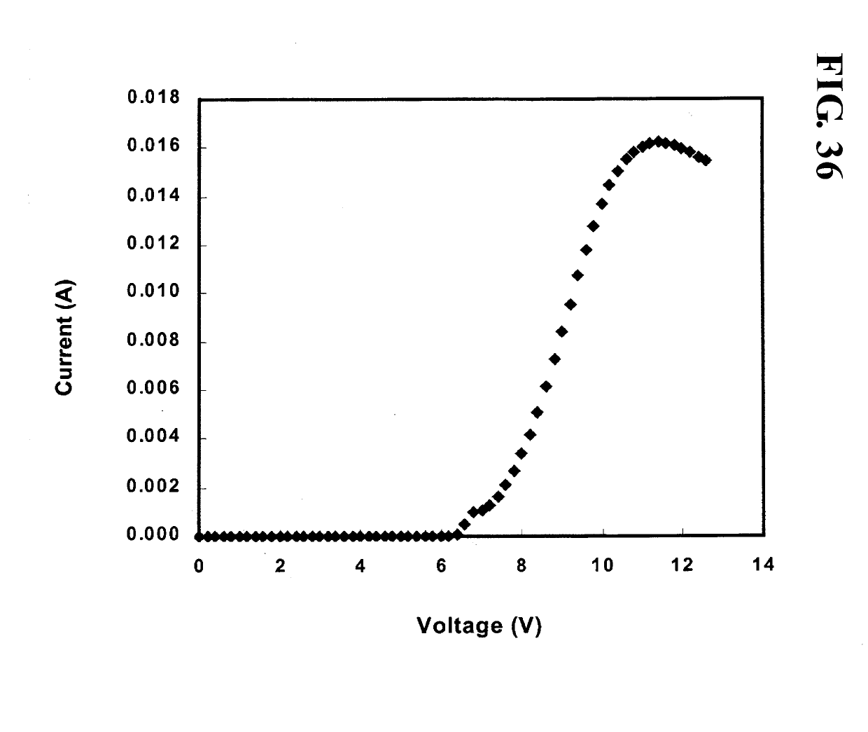

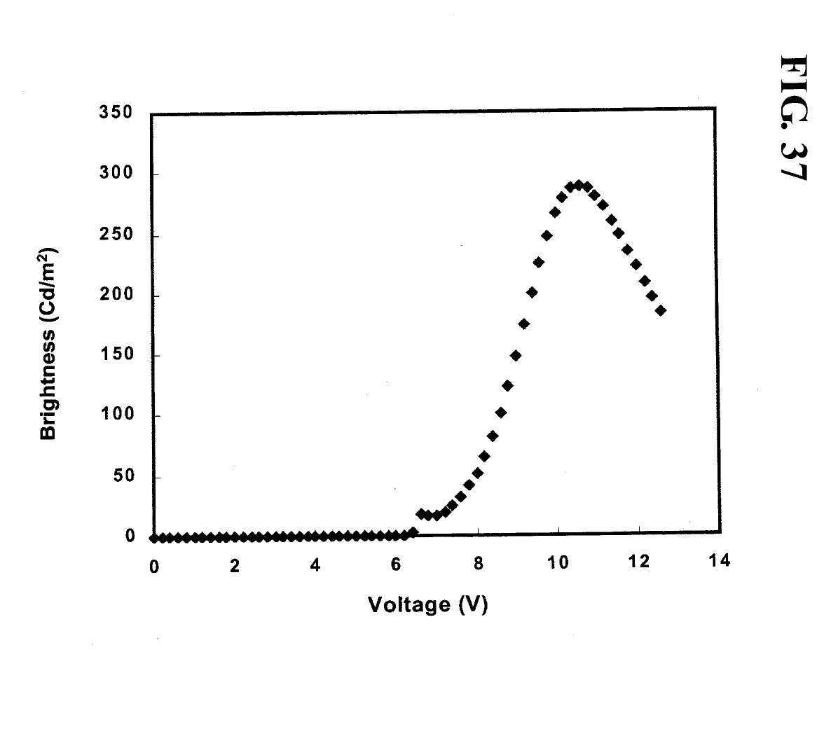

The organic EL device was evaluated for EL spectrum, current-voltage, luminance-voltage, efficiency and color properties, and the results are given in Table 7, below, and in FIGS. 35 to 37.

TABLE 7

| Test Item | Result |
|---|---|
| Turn-On Voltage (V) | 6.0 |
| Max. Brightness (Cd/m²) | 288.5 |
| Color | Blue (490 nm) |
| CIE | |
| Coordinate | |
| X | 0.23 |
| Y | 0.35 |

It is found from the results that the compound of the chemical formula 5, prepared in Preparation Example 4, emits blue light, showing a slight red-shift due to the presence of 9,9-dihexylflorene in comparison with the blue light of chemical formula 2 or 4.

In addition to being superior in terms of oxidation resistance, thermal stability and luminescent efficiency, the polymer containing 9,10-diphenylanthracene moiety of the present invention, as described hereinbefore, can be applied to electroluminescent devices by a simple process such as spin coating. With the introduction of suitable substituents, the organic electroluminescent polymers according to the present invention show electric conductivity in an appropriate level, as well as excluding the interference of excitons of a molecule with those of neighboring molecules as much as possible. Further, the high glass transition temperatures (Tg) and excellent thermal stability of the organic electroluminescent polymers of the present invention makes the EL device resistant to the heat generated during the operation of the EL device. Besides, a vacuum deposition or a spin coating method may be employed to form an organic film such as a light-emitting layer or a hole transport layer from the organic electroluminescent polymers of the present invention.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. An organic electroluminescent polymer, having a main chain consisting of 9,10-diphenylanthracene and vinylene, represented by the following chemical formula 1: 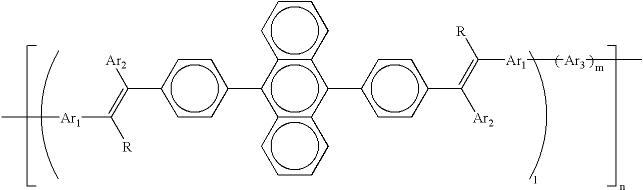
wherein,
Ar₁ and Ar₃ are identical or different, and are selected from the group consisting of:
a non-substituted, C1-C25 alkyl-substituted, or C1-C25 alkoxy-substituted arylene group of 6 to 30 carbon atoms; an arylene group of 10 to 24 atoms having fused aromatic ring; an arylene group of 6 to 30 carbon atoms, substituted with an alkyl amino group of 1 to 25 carbon atoms or with an aryl amino group of 6 to 30 carbon atoms; a carbazole derivative having an alkyl group of 1 to 25 carbon atoms or an aryl group of 6 to 30 carbon atoms; a fluorenylene group having, at position 9, an alkyl group of 1 to 25 carbon atoms, a polyalkoxide group of 1 to 25 carbon atoms, or an aryl group substituted with an alkyl or alkoxy group of 1 to 25 carbon atoms; a silylene group substituted with an alkyl group of 1 to 25 carbon atoms, an alkoxy group of 1 to 25 carbon atoms, or aryl group of 6 to 30 carbon atoms; and an arylene group of 6 to 30 carbon atoms having a silyl group substituted with an alkyl group of 1 to 25 carbon atoms, an alkoxy group of 1 to 25 carbon atoms or an aryl group of 6 to 30 carbon atoms;
Ar₂ and R are identical or different, and are selected from the group consisting of:
a hydrogen atom; a non-substituted, C1-C25 alkyl-substituted, or C1-C25 alkoxy-substituted aryl group of 6 to 30 carbon atoms; an aryl group of 10 to 24 atoms having fused aromatic ring; an aryl group of 6 to 30 carbon atoms, substituted with an alkyl amino group of 1 to 25 carbon atoms or with an aryl amino group of 6 to 30 carbon atoms; a carbazole derivative having an alkyl group of 1 to 25 carbon atoms or an aryl group of 6 to 30 carbon atoms; a fluorenyl group having, at position 9, an alkyl group of 1 to 25 carbon atoms, a polyalkoxide group of 1 to 25 carbon atoms, or an aryl group substituted with an alkyl or alkoxy group of 1 to 25 carbon atoms; a silyl group substituted with an alkyl group of 1 to 25 carbon atoms, an alkoxy group of 1 to 25 carbon atoms, or aryl group of 6 to 30 carbon atoms; an aryl group of 6 to 30 carbon atoms having a silyl group substituted with an alkyl group of 1 to 25 carbon atoms, an alkoxy group of 1 to 25 carbon atoms or an aryl group of 6 to 30 carbon atoms; and a cyano or fluoro group;
l is an integer of 1 to 100,000 and m is an integer of 0 to 50,000, with the proviso that l is not less than m; and
n is an integer of 1 to 100,000.

2. The organic electroluminescent polymer as defined in claim 1, wherein Ar₁ is a phenylene; Ar₂ is a phenyl; Ar₃ is 2-(2′-ethyl)hexyloxy-5-methoxyphenyl (2-2′-ethyl)hexyloxy-5-methoxy phenyl); R is a hydrogen atom; both l and m are 1; and n refers to n₂, n₂ being an integer of 1 to 100,000.

3. The organic electroluminescent polymer as defined in claim 1, wherein Ar₁ is a phenylene; Ar₂ is fluorenyl; R is a hydrogen atom; l is 1; m is 0; and n refers to n₃, n₃ being an integer of 1 to 100,000.

4. The organic electroluminescent polymer as defined in claim 1, wherein Ar₁ is a phenylene; Ar₂ is a 9,9-dihexylfluorenyl; Ar₃ is 2-(2′-ethyl)hexyloxy-5-methoxyphenyl; R is a hydrogen atom; both l and m are 1; and n refers to n₄, n₄ being an integer of 1 to 100,000.

5. The organic electroluminescent polymer as defined in claim 1, wherein Ar₁ is a phenylene; Ar₂ is a 9,9-dihexylfluorenyl; Ar₃ is a 9,9-dihexylfluorenylene; R is a hydrogen atom; both l and m are 1; and n refers to n₅, n₅ being an integer of 1 to 100,000.

6. An organic electroluminescent device, in which the organic electroluminescent polymer in accordance with claim 1 used as a material for a light-emitting layer, electron transport layer or hole transport layer.

7. The organic electroluminescent device as defined in claim 6, wherein the organic electroluminescent device has a structure of anode/light-emitting layer/cathode, anode/hole transport layer/light-emitting layer/cathode, or anode/hole transport layer/light-emitting layer/electron transport layer/cathode.

8. The organic electroluminescent device as defined in claim 6, which further comprises hole-blocking layer.
